(19) United States
(12) Patent Application Publication
(10) Pub. No.: US 2024/0174001 A1
(43) Pub. Date: May 30, 2024

(54) INK JET RECORDING METHOD AND INK JET RECORDING APPARATUS

(71) Applicant: CANON KABUSHIKI KAISHA, Tokyo (JP)

(72) Inventors: SHINYA YUMOTO, Kanagawa (JP); TSUYOSHI KANKE, Kanagawa (JP); ARIHIRO SAITO, Saitama (JP)

(21) Appl. No.: 18/517,179

(22) Filed: Nov. 22, 2023

(30) Foreign Application Priority Data
Nov. 25, 2022 (JP) 2022-188251
Nov. 25, 2022 (JP) 2022-188259
Nov. 17, 2023 (JP) 2023-196036

(51) Int. Cl. B41J 11/00; B41J 2/21; C09D 11/324; C09D 11/54

(52) U.S. Cl. CPC B41J 11/0022; B41J 2/2107; C09D 11/324; C09D 11/54

(57) ABSTRACT

Provided is an ink jet recording method capable of recording a high-quality image that is less liable to cause blocking and generate a scratch caused by tightening and that is free of unevenness even when a recording medium having been subjected to image recording is wound up into a roll. The ink jet recording method is a method of recording an image on a roll of recording medium with use of an aqueous ink and an aqueous reaction liquid. The ink jet recording method includes: a reaction liquid applying step of applying the reaction liquid to the recording medium; an ink applying step of applying the aqueous ink to the recording medium; a drying step of drying the aqueous ink by applying hot air; a cooling step of decreasing the surface temperature of the recording medium; and a wind-up step of winding up the cooled recording medium into a roll.

### BACKGROUND OF THE INVENTION

### Field of the Invention

The present invention relates to an ink jet recording method and an ink jet recording apparatus.

### Description of the Related Art

In recent years, use of an ink jet recording apparatus in a field of high-speed label printing or package printing has been considered. In such a field, in order to produce a large amount of recorded items in a short period of time, there has been adopted a method of, while unwinding and conveying a roll of recording medium, recording an image through application of an ink by one time of relative scanning (one pass) between a recording head and the recording medium. Moreover, there has also been a demand for recording an image on a recording medium having low ink absorbability (low-absorbability recording medium), for example, art paper having a thin coating layer thereon or a recording medium that substantially does not absorb an ink (non-absorbable recording medium), for example, a plastic film. Moreover, in view of, for example, environment or safety, use of an aqueous ink containing a pigment as a coloring material has been considered.

Up to now, it has been possible to use an aqueous ink to record a high-resolution image on a recording medium having high ink absorbability (absorbable recording medium), for example, plain paper. Meanwhile, an ink is less likely to permeate a low-absorbability recording medium or a non-permeable recording medium. Thus, before a preceding ink that has adhered to the recording medium permeates, a subsequent ink adheres adjacent to the preceding ink. As a result, ink droplets are liable to unite to cause blurs or unevenness, and hence it has been difficult to improve the quality of an image to be obtained. In order to solve such a problem, for example, there has been proposed a pretreatment liquid containing a polyvalent metal salt, which is a component that causes agglomeration of a pigment or a solid component in an ink to increase a viscosity of the ink (Japanese Patent Application Laid-Open No. 2018-134853).

Moreover, an image recorded by the method described above is formed of a pigment fixed on a surface of a recording medium, and hence the image is liable to be scratched due to abrasion on the surface. Thus, with regard to an image to be recorded with a pigment ink, in general, there has been a problem of improving abrasion resistance. In order to improve the abrasion resistance of an image to be recorded, for example, there has been proposed an ink set including: a reaction liquid containing a polyvalent metal ion that causes agglomeration of a pigment in an ink; and an ink containing a resin particle (Japanese Patent Application Laid-Open No. 2020-104487).

An aqueous ink for ink jet typically contains a water-soluble organic solvent, for example, an alcohol and water as liquid components, and water occupies a half or more of the liquid components. When the liquid components remain in a recorded image, the abrasion resistance of the image is lowered, and adhesion of the image in contact with other portions, which is so-called blocking, is liable to occur, which may result in a problem of causing damage to the image. Thus, in the field of label printing or package printing, in order to solve such a problem, a drying step of drying an ink having been applied to a recording medium by heating is generally performed.

The inventors of the present invention used the pretreatment liquid and the ink that have been proposed in Japanese Patent Application Laid-Open No. 2018-134853 and Japanese Patent Application Laid-Open No. 2020-104487 to record an image on a roll of non-absorbable recording medium through application of the pretreatment liquid and the ink by one time of relative scanning (one pass) between a recording head and the recording medium. Then, the recording medium having been subjected to the image recording was kept for a certain period of time in a state of being wound up in a roll. As a result, it was found that the blocking in which a recording face and a recording medium adhere to each other occurs so that the recorded image is liable to be damaged. Moreover, it was also found that, besides the damage caused by the blocking, storage of the recording medium in the state of being wound up in a roll causes damage like that made by abrasion (scratch) to the image. Further, it was also found that the quality of the image is lowered due to deformation, for example, warpage of the recording medium.

### SUMMARY OF THE INVENTION

Accordingly, an object of the present invention is to provide an ink jet recording method capable of recording a high-quality image that is less liable to cause blocking and generate a scratch caused by tightening and that is reduced in unevenness and warpage even when a recording medium having been subjected to image recording is wound up into a roll. In addition, another object of the present invention is to provide an ink jet recording apparatus to be used in the ink jet recording method.

That is, according to the present invention, there is provided an ink jet recording method of recording an image on a roll of recording medium with use of an aqueous ink and an aqueous reaction liquid containing a reactant that reacts with the aqueous ink, the ink jet recording method including: a reaction liquid applying step of applying the aqueous reaction liquid to the recording medium; an ink applying step of applying the aqueous ink to the recording medium so that a region to which the aqueous ink is applied and a region to which the reaction liquid is applied are at least partially overlap on the recording medium; a drying step of drying the aqueous ink by applying hot air such that a surface temperature of the recording medium is increased to 70° C. or more; a cooling step of decreasing the surface temperature of the recording medium given at a time point of 5 seconds after an end of the drying step by 20° C. or more; and a wind-up step of winding up the cooled recording medium into a roll.

Further features of the present invention will become apparent from the following description of exemplary embodiments with reference to the attached drawings.

### BRIEF DESCRIPTION OF THE DRAWINGS

FIG. 1A is a schematic view for illustrating an ink jet recording apparatus according to one embodiment of the present invention.

FIG. 1B is a schematic view for illustrating an ink jet recording apparatus according to another embodiment of the present invention.

FIG. 1C is a schematic view for illustrating an ink jet recording apparatus according to another embodiment of the present invention.

FIG. 1D is a schematic view for illustrating an example of an ink jet recording apparatus.

FIG. 1E is a schematic view for illustrating an ink jet recording apparatus according to another embodiment of the present invention.

FIG. 1F is a schematic view for illustrating an ink jet recording apparatus according to another embodiment of the present invention.

FIG. 2 is a perspective view for illustrating an example of a liquid applying device.

FIG. 3 is a sectional perspective view for illustrating an example of an ejection element substrate.

FIG. 4 is a schematic view for illustrating an example of a liquid supply system.

FIG. 5 is a schematic view for illustrating another example of a heating portion.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink and reaction liquid for ink jet are sometimes referred to simply as “ink” and “reaction liquid”. Physical property values are values at normal temperature (25° C.) and normal pressure (1 atm), unless otherwise stated. The descriptions “(meth)acrylic acid” and “(meth)acrylate” refer to “acrylic acid or methacrylic acid” and “acrylate or methacrylate”, respectively.

Hitherto, in an ink jet recording method using an aqueous ink, an ink containing a resin particle is used, and the resin particle is softened and formed into a film with heat applied at the time of, for example, drying, thereby improving abrasion resistance of an image. However, the aqueous ink contains much water with a large magnitude of latent heat, and hence it is required that heating to a higher temperature be performed for drying. Then, when the recording medium is wound up into a roll under a state in which the recording medium is at a high temperature and in which a component, for example, the resin particle in the image is softened, there arises a problem in that the blocking is liable to occur. Meanwhile, when a heating temperature given at the time of drying is low, liquid components are liable to remain in the image, and the component, for example, the resin particle is softened due to the presence of the remaining liquid components. Further, the image is poorly fixed, with the result that the blocking is liable to occur.

Moreover, when the image is dried by heating, the heat causes the recording medium to expand. When the recording medium is wound up in a state of being expanded, the recording medium shrinks due to cooling by heat radiation after being wound up, and a particularly large stress is generated in the direction of winding up, which results in a phenomenon in which the recording medium having been wound up into a roll is further tightened. Meanwhile, when a reaction liquid is used, the ink adhering to the recording medium is quickly increased in viscosity. As a result, dots of the ink are less likely to be smoothened (leveled), with the result that irregularities are liable to be formed in the image. Moreover, most of a reactant contained in the reaction liquid is consumed through a reaction with a component in the ink, for example, formation of a salt, but part of the reactant is present while remaining unreacted. As a result of investigations conducted by the inventors of the present invention, it was found that the unreacted reactant is present as spots in the image and at a non-recording portion of the recording medium having only the reaction liquid applied thereto and is deposited over time. It was found that the reactant that has been deposited comes into contact with irregularities on an image surface or with a back surface of the recording medium and causes a scratch on the image surface or the back surface of the recording medium due to the tightening described above, which lowers the quality of the image. When the image is recorded without use of the reaction liquid and with only the ink, the ink does not rapidly agglomerate. Thus, irregularities are less liable to be formed, and the problem of the blocking is less liable to arise. However, an image to be recorded is liable to be uneven.

Moreover, when a transparent film is used as the recording medium, transparency of the recording medium is liable to be impaired because the reactant is deposited as described above at the non-recording portion of the recording medium having only the reaction liquid applied thereto. Further, when the recording medium that has been dried by heating is left for a long period of time in a state of being heated, deformation, for example, warpage is liable to occur. This is presumably because the recording medium is softened by heating, and because the tension to be applied at the time of conveyance varies depending on a location, and natural heat radiation also varies depending on a location.

Under such circumstances, the inventors of the present invention conducted investigations on a method of recording a high-quality image that is less liable to cause the blocking and generate a scratch caused by tightening and that is reduced in unevenness and warpage even when a recording medium having been subjected to image recording is wound up into a roll. As a result, the inventors found that such problems may be solved with the following configuration, and achieved the present invention. That is, an ink jet recording method of the present invention is a recording method of recording an image on a roll of recording medium with use of an aqueous ink and an aqueous reaction liquid containing a reactant that reacts with the aqueous ink. The ink jet recording method of the present invention includes a reaction liquid applying step, an ink applying step, a drying step, a cooling step and a wind-up step. In the drying step, the aqueous ink is dried by applying hot air such that a surface temperature of the recording medium is increased to 70° C. or more. Then, in the cooling step, the surface temperature of the recording medium given at a time point of 5 seconds after an end of the drying step is decreased by 20° C. or more.

When heating is performed such that the surface temperature of the recording medium is increased to a high temperature of 70° C. or more, liquid components, for example, water with a large magnitude of latent heat can be effectively removed, thereby being capable of preventing occurrence of the blocking. Moreover, when drying is performed by applying hot air, the reactant that has been deposited at, for example, the non-recording portion of the recording medium can be removed by blowing the reactant away. In this manner, the damage to the image surface or the back surface of the recording medium caused by tightening can be prevented, and even when a transparent film is used as the recording medium, the transparency of the recording medium can be prevented from being impaired.

When the recording medium having been increased in temperature to a high temperature in the drying step is cooled in the cooling step, and is wound up into a roll under the state in which expansion of the recording medium is reduced, generation of a scratch caused by tightening can be prevented. Further, when the surface temperature of the recording medium given at a time point of 5 seconds after an end of the drying step is decreased by 20° C. or more, that is, when a predetermined recording medium is cooled in a short period of time, deformation of the recording medium can be prevented.

### <Ink Jet Recording Method and Ink Jet Recording Apparatus>

An ink jet recording method (hereinafter also simply referred to as “recording method”) of the present invention is a method of recording an image on a roll of recording medium with use of an aqueous ink and an aqueous reaction liquid containing a reactant that reacts with the aqueous ink. The recording method of the present invention includes a reaction liquid applying step, an ink applying step, a drying step, a cooling step and a wind-up step. The reaction liquid applying step is a step of applying the reaction liquid to the recording medium. The ink applying step is a step of applying the aqueous ink to the recording medium so that a region to which the aqueous ink is applied and a region to which the reaction liquid is applied are at least partially overlap on the recording medium. The drying step is a step of drying the aqueous ink by applying hot air such that a surface temperature of the recording medium is increased to 70° C. or more. The cooling step is a step of decreasing the surface temperature of the recording medium given at a time point of 5 seconds after an end of the drying step by 20° C. or more. Further, the wind-up step is a step of winding up the cooled recording medium into a roll.

An ink jet recording apparatus (hereinafter also simply referred to as “recording apparatus”) of the present invention is an apparatus to be used in an ink jet recording method including recording an image on a roll of recording medium with use of an aqueous ink and an aqueous reaction liquid containing a reactant that reacts with the aqueous ink. The recording apparatus of the present invention includes a reaction liquid application unit, an ink application unit, a drying unit, a cooling unit and a wind-up unit. The reaction liquid application unit is a unit configured to apply the reaction liquid to the recording medium. The ink application unit is a unit configured to apply the aqueous ink to the recording medium so that a region to which the aqueous ink is applied and a region to which the reaction liquid is applied are at least partially overlap on the recording medium. The drying unit is a unit configured to dry the aqueous ink by applying hot air such that a surface temperature of the recording medium is increased to 70° C. or more. The cooling unit is a unit configured to decrease the surface temperature of the recording medium given at a time point of 5 seconds after an end of the drying by 20° C. or more. Further, the wind-up unit is a unit configured to wind up the cooled recording medium into a roll.

### (Ink Jet Recording Apparatus)

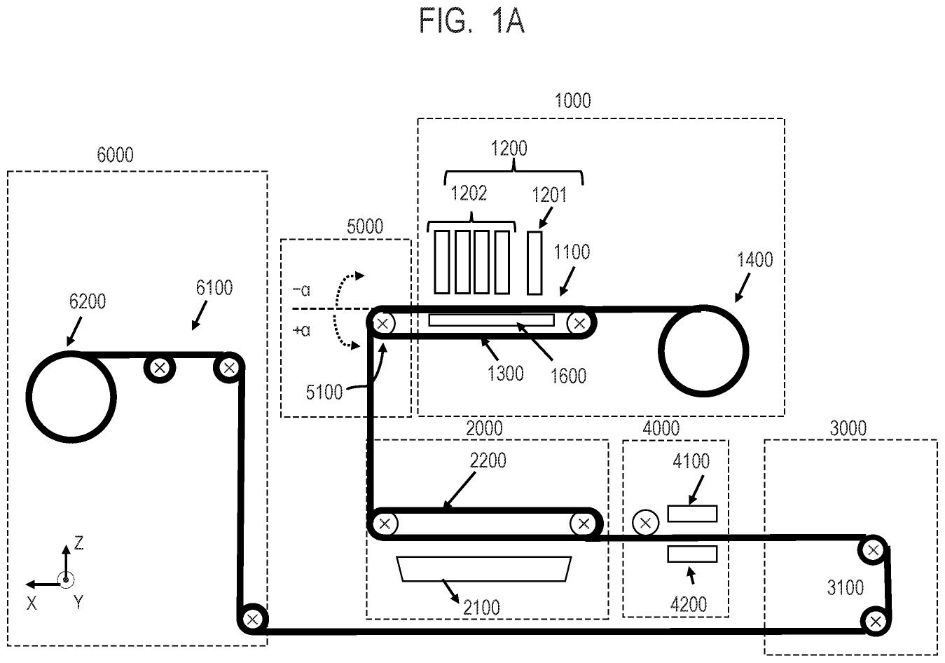

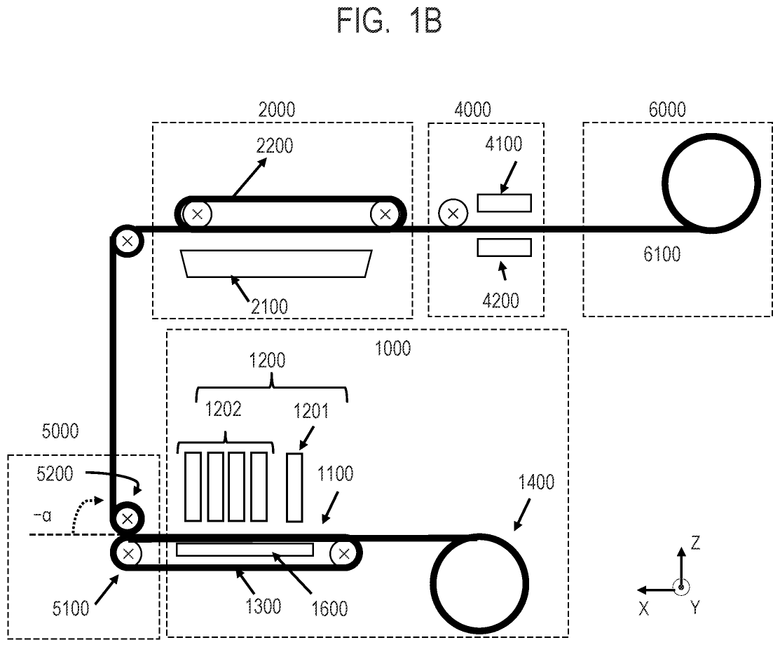

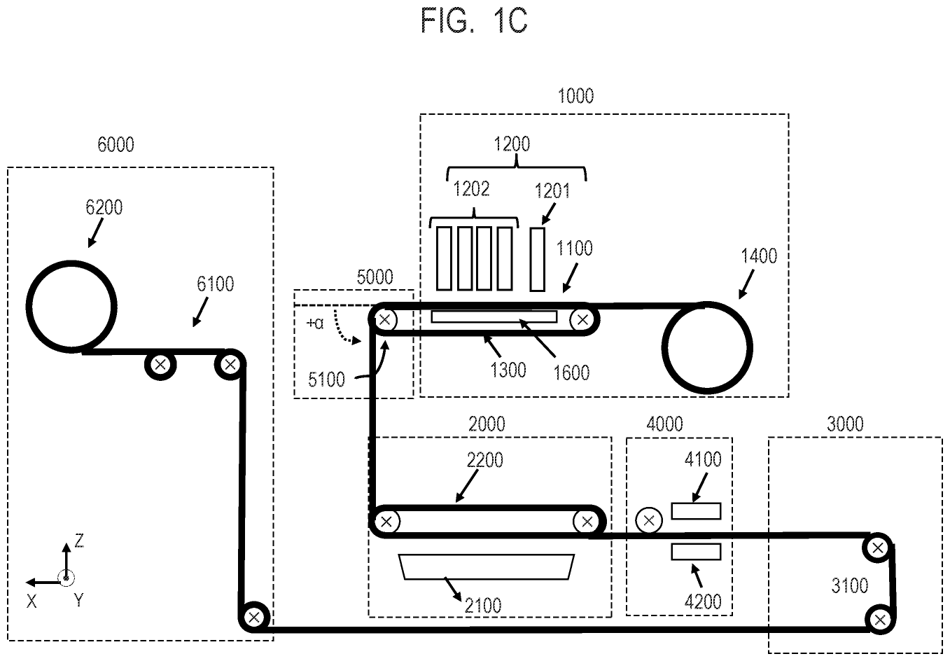

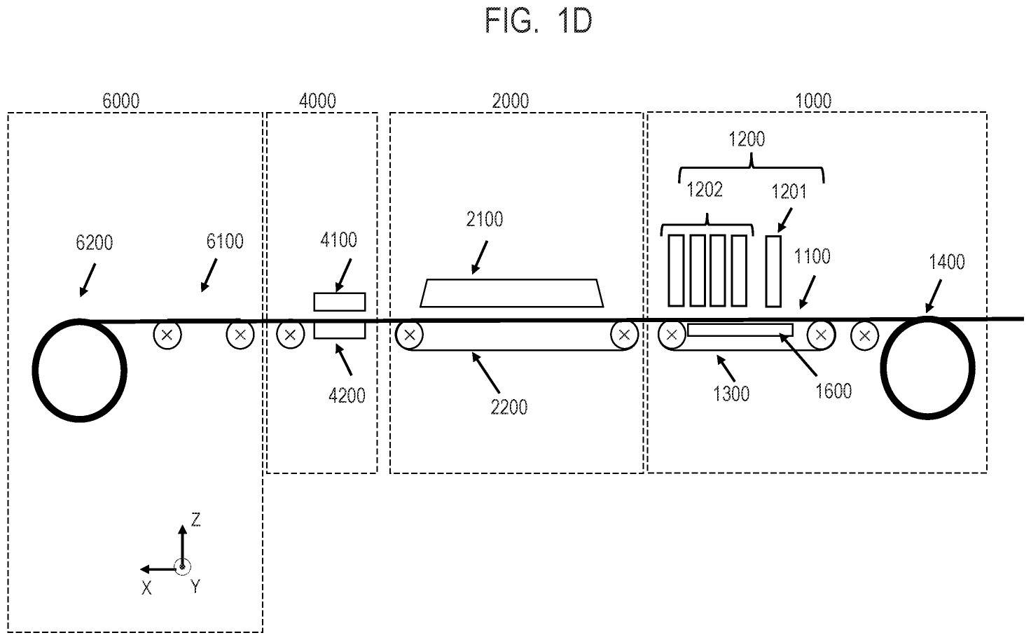

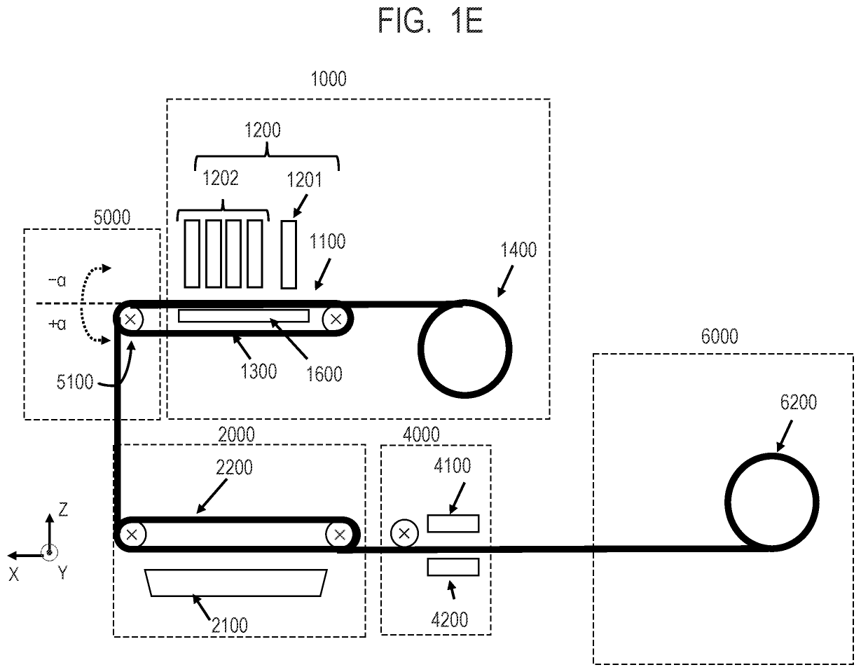

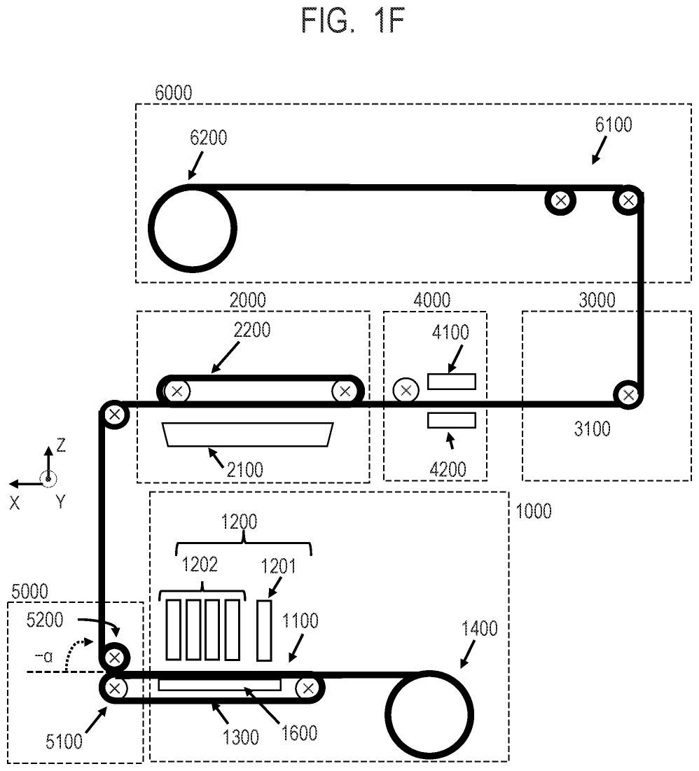

Details about the ink jet recording apparatus are described below with reference to the drawings. FIG. 1A is a schematic view for illustrating the ink jet recording apparatus according to one embodiment of the present invention. The ink jet recording apparatus of this embodiment is an ink jet recording apparatus that records an image on a recording medium with a reaction liquid containing a reactant that reacts with an ink and the ink. An X-direction, a Y-direction and a Z-direction represent the width direction (total length direction), depth direction and height direction of the ink jet recording apparatus, respectively. The recording medium is conveyed in the X-direction.

An ink jet recording apparatus of the embodiment illustrated in FIG. 1A includes: a recording portion 1000; a heating portion 2000; a fixing portion 3000; a cooling portion 4000; a bending portion 5000; and a wind-up portion 6000. In the recording portion 1000, various liquids are applied to a roll of recording medium 1100, which has been conveyed from a sheet feeding device 1400 by a conveying member 1300, by a liquid applying device 1200. In the heating portion 2000, the heating of the liquids applied to the recording medium 1100 by a heating device 2100 evaporates volatile components in the liquids such as moisture, to thereby dry the liquids. In the fixing portion 3000, a fixing member 3100 is brought into contact with the region of the recording medium 1100 having applied thereto the liquids to heat the region, to thereby accelerate the fixation of an image to the recording medium 1100. After that, the recording medium 1100 is cooled by the cooling member 4100 and 4200 of the cooling portion 4000. The recording medium 1000 having an image recorded thereon is conveyed while being supported by a conveying member 6100 and then wound up by a winding device 6200 in the winding portion 6000.

Any recording medium may be used as the recording medium 1100. For example, such a recording medium each having ink absorbability (permeability) as described below may each be used: a recording medium free of a coating layer, such as plain paper, uncoated paper or synthetic paper; and a recording medium including a coating layer, such as actual printing stock, glossy paper or art paper. In addition, a recording medium that does not have permeability like a film or a sheet formed from a resin material, such as polyvinyl chloride (PVC) or polyethylene terephthalate (PET), may be used.

The recording method of the present invention is suitable as a method of recording an image on a roll of non-ink-absorbable recording medium or a roll of recording medium having low ink absorbability. The term “non-ink-absorbable recording medium” as used herein means a recording medium with a water absorption amount of less than 5 mL/m² as measured by the Bristow method from the start of contact to 30 msec^{1/2}. Moreover, the term “recording medium having low ink absorbability” as used herein means a recording medium with a water absorption amount of 5 mL/m² or more to 10 mL/m² or less as measured by the Bristow method from the start of contact to 30 msec^{1/2}. In a case of a recording medium that is ink-absorbable, for example, plain paper with a water absorption amount of more than 10 mL/m² as measured by the Bristow method from the start of contact to 30 msec^{1/2}, air flows thereinto from the outside even when the recording medium is wound up into a roll. Thus, a negative pressure is less liable to be present in voids of the recording medium, and hence the problem of the blocking is less liable to arise.

Examples of the recording medium having low ink absorbability with a water absorption amount of 5 mL/m² or more to 10 mL/m² or less as measured by the Bristow method from the start of contact to 30 msec^{1/2} may include a recording medium having a thin coating layer thereon, such as art paper, high-quality coated paper, mid-quality coated paper, high-quality lightweight coated paper, mid-quality lightweight coated paper, lightly coated paper and cast-coated paper. Examples of the non-ink-absorbable recording medium with a water absorption amount of less than 5 mL/m² as measured by the Bristow method from the start of contact to 30 msec^{1/2} may include: synthetic films made of polymer compounds, such as polyethylene, polyethylene terephthalate, polypropylene and polyvinyl chloride; paper having the polymer compounds applied thereto; glass; metals; and ceramics. In particular, as the recording medium, it is preferred that a non-ink-absorbable recording medium with a water absorption amount of less than 5 mL/m² as measured by the Bristow method from the start of contact to 30 msec^{1/2} be used. Further, it is particularly preferred that a film or a sheet made of at least one kind of material selected from the group consisting of: polyethylene; polypropylene; nylon; polyethylene terephthalate; polyvinyl chloride; and a metal be used.

As the non-ink-absorbable recording medium described above, it is preferred that a film or a sheet in which a content of polymer compounds, such as polyethylene terephthalate, nylon, polyethylene and polypropylene, is 50% by mass or more based on a total mass of the recording medium be adopted. In particular, it is more preferred that a film or a sheet in which a content of polyethylene terephthalate or nylon is 70% by mass or more based on a total mass of the recording medium be adopted. Those non-ink-absorbable recording mediums are preferred because the amount of expansion by a change in temperature is smaller as compared to a general paper material having ink absorbability, which may prevent deformation even when a heating step is performed.

### [Recording Portion]

The recording portion 1000 includes the liquid applying device 1200. The liquid applying device 1200 includes a reaction liquid applying device 1201 and an ink applying device 1202. The reaction liquid applying device 1201 illustrated in FIG. 1A to FIG. 1F is an example of a unit using an ejection head of an ink jet system. The reaction liquid applying device may be formed by utilizing a gravure coater, an offset coater, a die coater, a blade coater or the like in addition to the ejection head. The reaction liquid may be applied by the reaction liquid applying device 1201 before the application of the ink or may be applied after the ink application as long as the liquid can be brought into contact with the ink on the recording medium 1100. However, to record a high-quality image on various recording mediums having different liquid-absorbing characteristics, the reaction liquid is preferably applied before the application of the ink. An ejection head (recording head) of an ink jet system is used as the ink applying device 1202. Examples of the ejection system of the ejection head serving as the liquid applying device 1200 may include: a system including causing film boiling in a liquid with an electro-thermal converter to form air bubbles, to thereby eject the liquid; and a system including ejecting the liquid with an electro-mechanical converter.

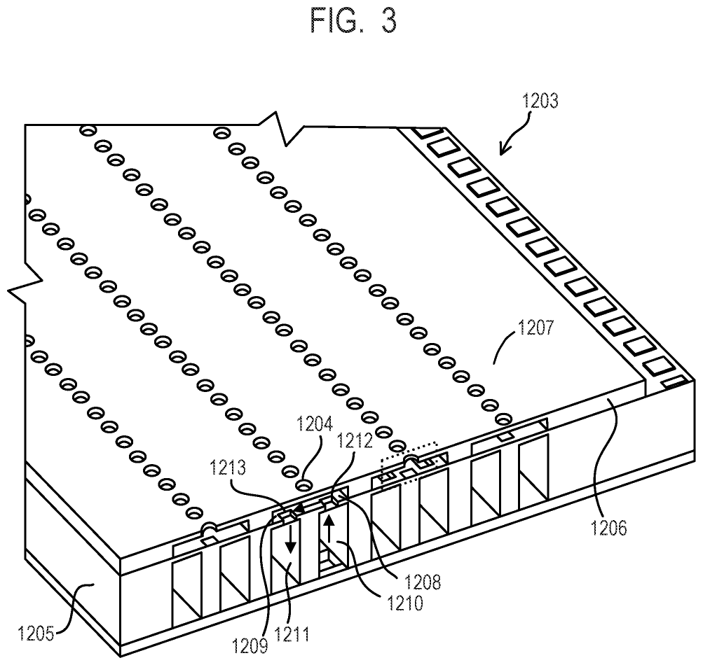

The liquid applying device 1200 is a line head arranged in the Y-direction in an extended manner and its ejection orifices are arrayed in a range covering the image recording region of the recording medium having the maximum usable width. The ejection head has an ejection orifice surface 1207 (FIG. 3) having formed therein ejection orifices on its lower side (recording medium 1100 side). The ejection orifice surface faces the recording medium 1100 with a minute distance of about several millimeters therebetween.

The plurality of ink applying devices 1202 may be arranged for applying inks of respective colors to the recording medium 1100. For example, when respective color images are recorded with a yellow ink, a magenta ink, a cyan ink and a black ink, the four ink applying devices 1202 that eject the above-mentioned four kinds of inks are arranged side by side in the X-direction. The ink and the reaction liquid are hereinafter sometimes collectively referred to as “liquids”.

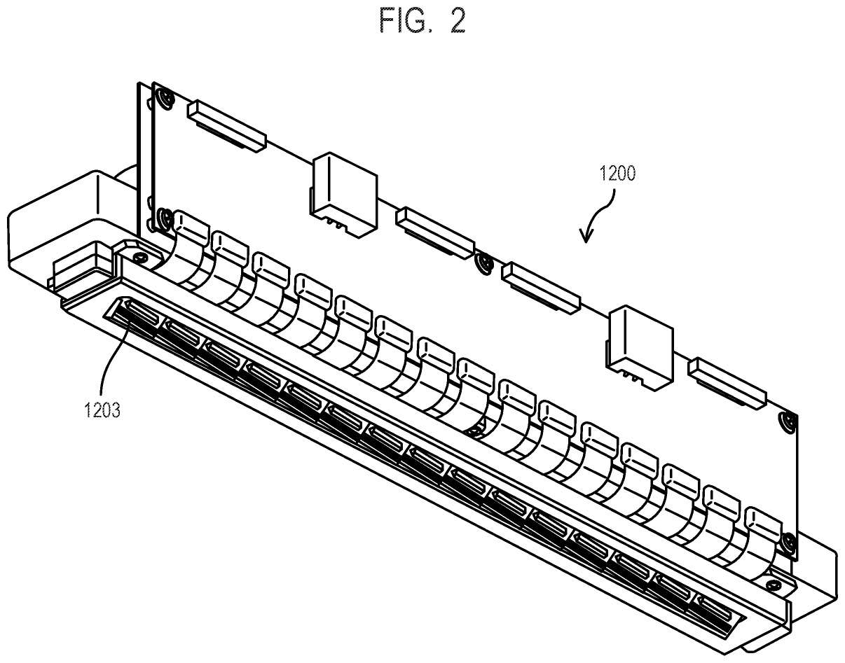

FIG. 2 is a perspective view for illustrating an example of the liquid applying device. The liquid applying device 1200 illustrated in FIG. 2 is a line head and a plurality of ejection element substrates 1203 having arranged therein ejection orifice arrays are linearly arrayed. The ejection element substrates 1203 each have arrayed therein a plurality of ejection orifice arrays.

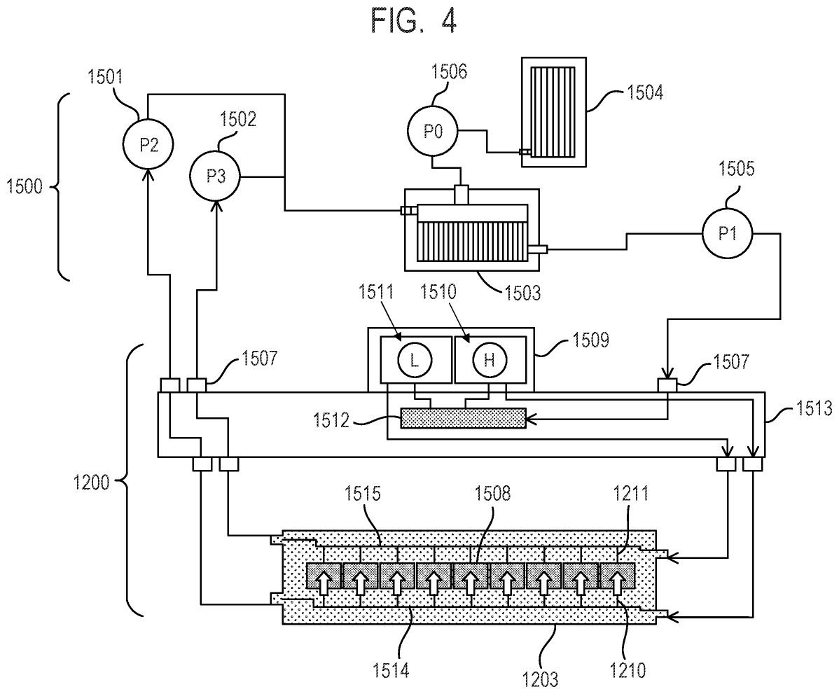

FIG. 3 is a sectional perspective view for illustrating an example of each of the ejection element substrates. The ejection element substrate 1203 illustrated in FIG. 3 includes: an ejection orifice forming member 1206 having opened therein ejection orifices 1204; and a substrate 1205 having arranged thereon an ejection element (not shown). The lamination of the ejection orifice forming member 1206 and the substrate 1205 forms a first flow path 1208 and a second flow path 1209 through which a liquid flows. The first flow path 1208 is a region from an inflow port 1212, into which the liquid flows from an inflow path 1210, to a portion between each of the ejection orifices 1204 and the ejection element (FIG. 4, a liquid chamber 1508). In addition, the second flow path 1209 is a region from the portion between the ejection orifice 1204 and the ejection element (FIG. 4, the liquid chamber 1508) to an outflow port 1213 from which the liquid flows out to an outflow path 1211. For example, when a pressure difference is made between the inflow port 1212 and the outflow port 1213 like the inflow port 1212 having a high pressure and the outflow port 1213 having a low pressure, the liquid can be flowed from the high pressure to the low pressure (in a direction indicated by the arrows in FIG. 3). The liquid that has passed the inflow path 1210 and the inflow port 1212 enters the first flow path 1208. Then, the liquid that has gone through the portion between the ejection orifice 1204 and the ejection element (FIG. 4, the liquid chamber 1508) flows to the outflow path 1211 via the second flow path 1209 and the outflow port 1213.

### [Supply System]

FIG. 4 is a schematic view for illustrating an example of a supply system for the liquids such as the ink. A supply portion 1500 of the liquid applying device 1200 illustrated in FIG. 4 includes: a first circulation pump (high-pressure side) 1501; a first circulation pump (low-pressure side) 1502; a sub tank 1503; and a second circulation pump 1505. The sub tank 1503 connected to a main tank 1504 serving as a liquid storage portion has an air communication port (not shown) and hence can discharge air bubbles mixed into a liquid to the outside of a circulation system. The sub tank 1503 is also connected to a replenishment pump 1506. A liquid is consumed in the liquid applying device 1200 by the ejection (discharge) of the liquid from an ejection orifice in, for example, image recording or suction recovery. The replenishment pump 1506 transfers the liquid corresponding to the consumed amount from the main tank 1504 to the sub tank 1503.

The first circulation pump (high-pressure side) 1501 and the first circulation pump (low-pressure side) 1502 each flow the liquid in the liquid applying device 1200 that has been flowed out of a connection portion (inflow portion) 1507 to the sub tank 1503. A positive-displacement pump having a quantitative liquid-delivering ability is preferably used as each of the first circulation pump (high-pressure side) 1501, the first circulation pump (low-pressure side) 1502 and the second circulation pump 1505. Examples of such positive-displacement pump may include a tube pump, a gear pump, a diaphragm pump and a syringe pump. At the time of the driving of each of the ejection element substrates 1203, the liquid can be flowed from a common inflow path 1514 to a common outflow path 1515 by the first circulation pump (high-pressure side) 1501 and the first circulation pump (low-pressure side) 1502.

A negative pressure control unit 1509 includes two pressure adjusting mechanisms in which control pressures different from each other are set. A pressure adjusting mechanism (high-pressure side) 1510 and a pressure adjusting mechanism (low-pressure side) 1511 are connected to the common inflow path 1514 and the common outflow path 1515 in the ejection element substrate 1203 via a supply unit 1513 having arranged therein a filter 1512 that removes foreign matter from a liquid, respectively. The ejection element substrate 1203 has arranged therein the common inflow path 1514, the common outflow path 1515, and the inflow path 1210 and the outflow path 1211 that communicate to the liquid chamber 1508 serving as a portion between each of the ejection orifices 1204 and the ejection element (not shown). The inflow path 1210 and the outflow path 1211 communicate to the common inflow path 1514 and the common outflow path 1515, respectively. Accordingly, a flow (arrow in FIG. 4) in which part of the liquid passes the inside of the liquid chamber 1508 from the common inflow path 1514 to flow to the common outflow path 1515 occurs. The arrows in FIG. 4 indicate the flow of the liquid in the liquid chamber 1508. That is, as illustrated in FIG. 3, the liquid in the first flow path 1208 flows to the second flow path 1209 via a space between the ejection orifice 1204 and the ejection element.

As illustrated in FIG. 4, the pressure adjusting mechanism (high-pressure side) 1510 is connected to the common inflow path 1514 and the pressure adjusting mechanism (low-pressure side) 1511 is connected to the common outflow path 1515. Accordingly, a pressure difference occurs between the inflow path 1210 and the outflow path 1211. Thus, a pressure difference also occurs between the inflow port 1212 (FIG. 3) communicating to the inflow path 1210 and the outflow port 1213 (FIG. 3) communicating to the outflow path 1211. When a liquid is flowed by the pressure difference between the inflow port 1212 and the outflow port 1213, the flow rate (mm/s) of the liquid is preferably controlled to 0.1 mm/s or more to 10.0 mm/s or less.

### [Conveyance System]

As illustrated in FIG. 1A to FIG. 1F, the recording portion 1000 includes the liquid applying device 1200 and the conveying member 1300 that conveys the recording medium 1100. The reaction liquid and the ink are applied to the desired positions of the recording medium 1100, which is conveyed by the conveying member 1300, by the liquid applying device 1200. The respective liquid applying devices receive the image signal of recorded data to apply the required reaction liquid and ink to the respective positions. Although the conveying member 1300 in the form of a conveying belt is illustrated in FIG. 1A to FIG. 1F, for example, a spur or a conveying cylinder may be utilized as long as the spur or the cylinder has a function of conveying the recording medium 1100. A member that can fix the recording medium 1100 may be used as the conveying member 1300 for improving conveyance accuracy. Specific examples thereof may include: an approach including arranging holes in the conveying member 1300 and sucking the recording medium 1100 from its rear surface side to fix the recording medium; and an approach including forming the conveying member 1300 from an appropriate material and electrostatically adsorbing the recording medium 1100 to fix the recording medium.

A conveying speed (recording speed) for the recording medium is preferably 1 m/min or more to 200 m/min or less, more preferably 5 m/min or more to 100 m/min or less. When the recording speed is less than 5 m/min, a time interval of application of the reaction liquid and the ink becomes longer. Thus, before the ink and the reaction liquid come into contact with each other on the recording medium, dots of a preceding liquid having been applied to the recording medium are liable to move, and the image is liable to be uneven, with the result that an effect of further improving the evenness may not be sufficiently obtained. Meanwhile, when the recording speed is more than 100 m/min, time for bending the recording medium becomes shorter. Thus, the irregularities of the image cannot be sufficiently flattened, with the result that an effect of further improving the blocking resistance may not be sufficiently obtained.

### [Bending Portion]

A bending portion 5000 is provided between a recording portion 1000 and a heating portion 2000, and includes a conveyance roller 5100 that conveys a roll of recording medium 1100 having a reaction liquid and an ink applied thereto. The conveyance roller 5100 allows the recording medium 1100 to be conveyed while being bent. When the recording medium 1100 is bent under a state in which liquid components remain thereon immediately after the reaction liquid and the ink have been applied thereto, the irregularities of the image are evenly flattened in such a manner as to flow in the direction of bending accordingly. In this manner, the blocking that is liable to occur after winding up the recording medium 1100 can be effectively prevented. When the recording medium 1100 is bent under a state in which the liquid components in the image have been evaporated, the fluidity of the image is low, and hence the irregularities of the image cannot be flattened effectively, with the result that the effect of further improving the blocking resistance may not be obtained. Thus, it is preferred that the bending portion 5000 be installed between the recording portion 1000 and the heating portion 2000.

In the bending portion 5000, it is preferred that the recording medium 1100 be bent with a recording face (front surface, or face on which an image is to be recorded) facing outward. When the recording medium is bent (mountain-folded) with the recording face facing outward, the image is stretched, and hence the irregularities of the image can be flattened more effectively, thereby being capable of further improving the blocking resistance. As illustrated in FIG. 1B and FIG. 1F, when the recording medium 1100 is bent (valley-folded) with the recording face facing inward, it is preferred that a member, for example, a conveyance roller 5200 be provided at a position of bending the recording medium 1100. In this manner, the recording medium 1100 can be bent under a state in which the conveyance roller 5200 is in contact with the surface of the image, and the irregularities of the image can be flattened, thereby being capable of improving the blocking resistance. However, when the recording medium 1100 is bent under a state in which a large amount of liquid components remain in the image, the image is more liable to be transferred to the conveyance roller 5200, with the result that an image to be recorded may be more liable to be damaged.

In the bending portion 5000, it is preferred that the recording medium 1100 be bent at a bending angle α of 80° or more. The “bending angle” of the recording medium herein is a positive angle (+α(°)) when the recording medium is bent with the recording face facing outward, and is a negative angle (−α(°)) when the recording medium is bent with the recording face facing inward. When the recording medium is bent at a bending angle of 80° or more, the irregularities of the image are flattened effectively, thereby being capable of improving the blocking resistance. It is preferred that the bending angle α be 100° or less, more preferably 90° or less.

In the bending portion 5000, it is preferred that the recording medium 1100 be bent with a bending radius of 20 cm or less. When the bending radius is 20 cm or less, the recording medium can be bent more acutely, and hence the irregularities of the image can be flattened effectively, thereby being capable of further improving the blocking resistance. The bending radius is preferably 5 cm or more, more preferably 10 cm or more. The bending radius may be set, for example, based on a curvature radius of the conveyance roller 5100.

At the time of the application of the liquids such as the reaction liquid and the ink to the recording medium 1100, it is preferred that the recording medium 1100 be substantially not heated. Specifically, it is preferred that the recording medium be substantially not heated at the position of applying the reaction liquid and the ink. When the recording medium is heated, evaporation of the liquid components from the ink droplets adhering to the recording medium 1100 is fostered, and the fluidity of the ink is increased, with the result that the irregularities of the image may be less likely to be flattened even when the recording medium 1100 is bent in the bending portion 5000. As a result, the effect of further improving the blocking resistance may not be sufficiently obtained.

### [Heating Portion]

As illustrated in FIG. 1A to FIG. 1F, the heating portion 2000 includes the heating device 2100 and a conveying member 2200. The recording medium 1100 having recorded thereon the image through the application of the reaction liquid and the ink is heated by the heating device 2100 while being conveyed by the conveying member 2200. Thus, the liquid components of the image are evaporated and dried. Thus, the presence of such drying step can effectively suppress the deformation (cockling or curl) of the recording medium 1100.

The heating device 2100 may have any configuration as long as the ink can be dried by applying hot air so that the surface temperature of the recording medium 1100 is above a predetermined temperature. Conventionally known various devices, such as a warm-air dryer and a heater, may each be used. Of those, a non-contact-type heater, such as a heating wire and an infrared heater, is preferably utilized in terms of safety and energy efficiency. In addition, the utilization of the following mechanism easily improves the drying efficiency: the mechanism has built therein a fan for jetting a heated gas on the recording medium 1100 and blows warm air thereto.

With regard to a method for the heating, the recording medium 1100 may be heated from the side of the surface (recording surface (front surface)) having applied thereto the reaction liquid and the ink, may be heated from its rear surface side or may be heated from both the surfaces. A heating function may be imparted to the conveying member 2200. In particular, it is preferred that the hot air be applied to the front surface of the recording medium under a state in which the face having the reaction liquid and the ink applied thereto (front surface of the recording medium) faces downward because generation of a scratch caused by tightening can be further prevented. It is assumed that the reason thereof is because the irregularities formed in the image can be reduced as compared to a case in which the recording medium is conveyed and dried under a state in which the front surface of the recording medium faces in a direction other than the downward direction due to a way of evaporation of a water content and a resistance of the hot air.

Although the conveying member 2200 utilizing a conveying belt are illustrated in FIG. 1A to FIG. 1F, for example, a spur or a conveying cylinder may be utilized as long as the spur or the cylinder has a function of conveying the recording medium 1100. From the viewpoint of suppressing the deformation of the recording medium 1100 by the heating, a configuration, which blows air from the heating portion 2000 to convey the recording medium 1100 while bringing the recording medium into close contact with the conveying member 2200, or a mechanism that fixes the recording medium to the conveying member 2200 is preferably arranged. Specific examples thereof may include: an approach including arranging holes in the conveying member 2200 and sucking the recording medium 1100 from its rear surface side to fix the recording medium; and an approach including forming the conveying member 2200 from an appropriate material and electrostatically adsorbing the recording medium 1100 to fix the recording medium.

A heating temperature is preferably set so that a liquid component may be quickly evaporated and so that the recording medium 1100 may not be overdried from the viewpoint of suppressing the deformation of the recording medium 1100. Based on a conveying speed and an environmental temperature, the ink is dried by applying hot air such that the surface temperature of the recording medium is increased to 70° C. or more, preferably 70° C. or more to 110° C. or less. The surface temperature of the recording medium may be measured in any of a contact manner and a non-contact manner. In particular, it is preferred that an infrared radiation thermometer of a non-contact type be used to measure the surface temperature of the recording medium from the front surface (recording face) side. The wind speed of the hot air applied to the recording medium is preferably set to 1 m/s or more to 100 m/s or less. The temperature of air such as warm air may be measured with a K-type thermocouple thermometer. A measuring machine may be specifically, for example, a machine available under the product name “AD-5605H” (manufactured by A&D Company, Limited).

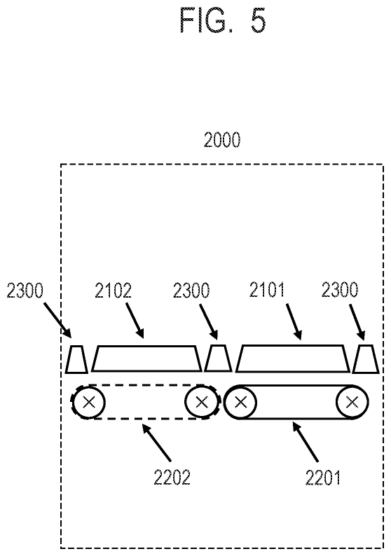

FIG. 5 is a schematic view for illustrating another example of the heating portion. Herein, a difference from the heating portion described in FIG. 1A to FIG. 1F and the foregoing is described. The heating portion 2000 illustrated in FIG. 5 includes: a first heating device 2101 and a second heating device 2102; and a first conveying member 2201 and a second conveying member 2202 arranged to face the first heating device 2101 and the second heating device 2102, respectively.

A mechanism that sucks and fixes the recording medium 1100 is not arranged in the first conveying member 2201. In addition, warm air from the first heating device 2101 presses the recording medium 1100 against the first conveying member 2201, to thereby convey the recording medium 1100. Thus, the recording medium 1100 can be delivered from the conveying member 1300 (FIG. 1A to FIG. 1F) to the first conveying member 2201 and from the first conveying member 2201 to the second conveying member 2202 with high accuracy. Further, a conveyance shift due to a slight difference in conveying speed between the conveying member 1300 (FIG. 1A to FIG. 1F) and the first conveying member 2201 can be reduced. Meanwhile, a conveying belt having arranged therein holes that can pass a gas therethrough is utilized as the second conveying member 2202 and the recording medium 1100 is conveyed while being fixed to the second conveying member 2202 via a suction mechanism (not shown).

Air knives 2300 are arranged between the conveying member 1300 (FIG. 1A to FIG. 1F) and the first conveying member 2201, between the first conveying member 2201 and the second conveying member 2202 and on the downstream side of the second conveying member 2202, respectively. The lifting of the tip portion of the recording medium 1100, which has been conveyed, is pressed down with an air pressure from the air knives 2300. Thus, the collision of the tip portion of the recording medium 1100 with the first heating device 2101, the second heating device 2102 and the like is avoided and hence the occurrence of a conveyance failure can be suppressed.

The first heating device 2101 and the second heating device 2102 may each have the same configuration as that of the above-mentioned heating device 2100. The temperatures of the first heating device 2101 and the second heating device 2102 may be identical to or different from each other. The hot air speeds may also be identical to or different from each other. In addition, the recording medium may be heated from the first conveying member 2201 and the second conveying member 2202 as required.

### [Fixing Portion]

As illustrated in FIG. 1A, a fixing portion 3000 includes conveyance rollers 3100. The recording medium 1100 is conveyed by the conveyance rollers 3100, and the conveyance rollers 3100 are brought into contact with the image on the recording medium 1100 so that the image can be fixed to the recording medium 1100 by the contact pressure. That is, it is preferred that a fixing step of fixing the image by applying pressure to the recording face be further provided after the heating step. The pressure to be applied to the recording face of the recording medium (contact pressure of the conveyance rollers) is preferably 10 Pa or more to 1,000 Pa or less, more preferably 10 Pa or more to 500 Pa or less, particularly preferably 10 Pa or more to 100 Pa or less. Further, it is particularly preferred that the pressure be 30 Pa or more so that the irregularities of the image can be flattened effectively, thereby being capable of further improving the blocking resistance. Moreover, it is preferred that the time required for the recording medium to pass through the conveyance rollers (nipping time) be 0.01 second or more to 5.0 seconds or less.

### [Cooling Portion]

The cooling portion 4000 includes the cooling member 4100 and a conveying member 4200 (FIG. 1A to FIG. 1F). The cooling portion 4000 cools the recording medium 1100 that has passed the heating portion 2000 and the fixing portion 3000 to have a high temperature. The cooling member 4100 may have any configuration as long as the member can cool the recording medium 1100. Approaches, such as air cooling and water cooling, may each be utilized. Of those, an approach including blowing a gas that is not heated is preferred in terms of safety and energy efficiency. In addition, the utilization of the following mechanism easily improves cooling efficiency: the mechanism has built therein a fan for jetting a gas on the recording medium 1100 and blows air thereto. Further, in a cooling portion 4000, it is preferred that air be blown to the front surface and the back surface of the recording medium 1100 to decrease the surface temperature of the recording medium 1100. In such a manner, deformation of the recording medium can be prevented more effectively.

In the cooling portion 4000, the recording medium is cooled such that the surface temperature of the recording medium given at a time point of 5 seconds after an end of the drying step in the heating portion 2000 is decreased by 20° C. or more, preferably 25° C. or more. A magnitude of decreasing the surface temperature is preferably 80° C. or less, more preferably 60° C. or less. The temperature of the recording medium having been cooled in the cooling portion is preferably 20° C. or more and is preferably 50° C. or less, more preferably 40° C. or less. When the temperature falls within the ranges, generation of a scratch caused by tightening can be further prevented.

In addition, in view of a conveying speed and an environmental temperature, the temperature of the cooling unit may be set so that the image of the recording medium has a desired temperature. Specifically, the temperature of the cooling unit (e.g., air) is set to preferably 20° C. or more to 50° C. or less, more preferably 20° C. or more to 40° C. or less. When a gas is blown to cool the recording medium 1100, a blowing speed is preferably set to 1 m/s or more to 100 m/s or less. With such conditions, deformation of the recording medium 1100 to be wound up into a roll in a wind-up portion 6000 described later and adhesion of the image (blocking) can be further prevented.

### [Wind-Up Portion]

The recording medium 1100 having been subjected to the image recording is accommodated in the wind-up portion 6000 (FIG. 1A to FIG. 1F). After the image has been recorded, the recording medium 1100 having passed through the cooling portion 4000 is conveyed by a conveyance member 6100, and is finally accommodated in a recording-medium accommodating portion 6200 in a state of having been wound up in a roll. It is preferred that the recording medium 1100 be wound up with the recording face of the recording medium 1100 being located on an outer side. When the recording medium 1100 is wound up with the recording face being located on an outer side, the image on the recording face is stretched, and hence the irregularities of the image are flattened more effectively, thereby being capable of further improving the blocking resistance.

### (Recording Method)

In the recording method of the present invention, the image is recorded by applying the ink and the reaction liquid to the recording medium while conveying the roll of recording medium. When the reaction liquid is ejected from a recording head employing an ink jet system to apply the reaction liquid to the recording medium, an application amount of the reaction liquid to the recording medium is preferably 8.0 mg/inch² or less. Moreover, the application amount is more preferably 4.0 mg/inch² or less, particularly preferably 0.1 mg/inch² or more. When the application amount of the reaction liquid falls within the ranges described above, the energy load in the drying step can be reduced. It is preferred that the application amount of the reaction liquid to the recording medium be suitably adjusted in accordance with the application amount of the ink. Moreover, it is preferred that the application amount of the ink to the recording medium be 15.0 mg/inch² or less and be 0.1 mg/inch² or more. When the application amount of the ink to the recording medium falls within the ranges described above, the energy load in the drying step can be reduced.

The reaction liquid is a component that is to be used for fixing the ink to the recording medium. Thus, in order to record an image that is more uniform and higher in quality, it is preferred that an application ratio of the reaction liquid and the ink be controlled within an appropriate range. Specifically, it is preferred that the application amount of the reaction liquid to the recording medium be given with a ratio of 0.08 times or more to 0.40 times or less in terms of a mass ratio with respect to the application amount of the ink to the recording medium. When the ratio described above is 0.08 times or more, the blocking resistance can be further improved. Moreover, when the mass ratio described above is 0.40 times or less, uniformity of an image to be recorded can be further improved.

### <Reaction Liquid>

The recording method of the present invention includes a reaction liquid applying step of applying an aqueous reaction liquid, which contains a reactant that reacts with the aqueous ink, to the recording medium. Respective components to be used in the reaction liquid and the like are described in detail below.

### [Reactant]

The reaction liquid is brought into contact with the ink to react with the ink, to thereby aggregate components (a resin, a surfactant, and a component having an anionic group such as a self-dispersible pigment) in the ink. The reaction liquid contains the reactant. When the reactant is present, at the time of contact between the ink and the reactant in the recording medium, the state of presence of the component having an anionic group in the ink is destabilized and hence the aggregation of the ink can be accelerated. Examples of the reactant may include: a polyvalent metal ion; a cationic component such as a cationic resin; and an organic acid. The reactants may be used alone or in combination thereof. In particular, in view of the stability in storage of the reaction liquid and a property of being less liable to cause corrosion of members of the ink jet recording apparatus, it is preferred that a cationic component, such as a polyvalent metal ion or a cationic resin, be used as a reactant. In particular, in view of good reactivity and excellent image properties, the polyvalent metal ion is preferred. Among reactants, the polyvalent metal ion and the cationic resin are more liable to damage the image surface and the back surface of the recording medium due to the tightening when an unreacted reactant is deposited, as compared to organic acids. However, when the drying step and the cooling step as defined in the present invention are satisfied, generation of a scratch caused by tightening can be prevented even when the polyvalent metal ion or the cationic resin is used.

Examples of the polyvalent metal ion forming a polyvalent metal salt may include: divalent metal ions, such as Ca²⁺, Cu²⁺, Ni²⁺, Mg²⁺, Sr²⁺, Ba²⁺ and Zn²⁺; and trivalent metal ions, such as Fe³⁺, Cr³⁺, Y³⁺ and Al³⁺. A water-soluble polyvalent metal salt (which may be a hydrate) made up of the polyvalent metal ion and an anion bonded to each other may be used to incorporate the polyvalent metal ion into the reaction liquid. Examples of such anion may include: inorganic anions, such as Cl⁻, Br⁻, I⁻, ClO®, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; and organic anions, such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻.

A water solubility of the polyvalent metal salt at 20° C. is preferably 1% by mass or more to 50% by mass or less, more preferably 8% by mass or more to 30% by mass or less. When the water solubility of the polyvalent metal salt is excessively low, the amount of the polyvalent metal ion in the reaction liquid is excessively small so that agglomeration of the ink may become weaker, with the result that uniformity of a solid image may be lowered. Meanwhile, when the water solubility of the polyvalent metal salt is excessively high, the image is more liable to absorb a water content in the air. Thus, the blocking resistance is more liable to be lowered, and a friction coefficient of the image surface may be increased, with the result that a scratch caused by tightening may be more liable to be generated. Moreover, the polyvalent metal salt may be less likely to be deposited even after drying, with the result that the reactant may not be completely removed even after air blowing. The term “water solubility at 20° C.” as used herein is defined as a mass of an anhydrous compound contained in 100 g of a saturated solution at a temperature of 20° C. (g)/100 (g)×100 (% by mass). For example, the phrase “the water solubility at 20° C. is 1% by mass” means that the amount of an anhydrous compound dissolved in 100 g of water at a temperature of 20° C. is 1 g.

Among polyvalent metal salts formed of a polyvalent metal ion and an anion bonded to each other, magnesium sulfate is preferred. When magnesium sulfate is used as the polyvalent metal salt, an agglomeration rate of a pigment and a resin particle in the ink can easily be controlled through adjustment of a content in the reaction liquid or an application amount of the reaction liquid. Thus, it is possible to reduce the irregularities of the image surface having been subjected to recording, thereby being capable of further preventing generation of a scratch caused by tightening. Moreover, even when a transparent film is used as the recording medium, the transparency of the recording medium can be effectively prevented from being impaired.

When the polyvalent metal ion is used as the reactant, its content (% by mass) in terms of polyvalent metal salt in the reaction liquid is preferably 1.0% by mass or more to 20.0% by mass or less and more preferably 1.0% by mass or more to 10.0% by mass or less with respect to the total mass of the reaction liquid. In this specification, when the polyvalent metal salt is a hydrate, the “content (% by mass) of the polyvalent metal salt” in the reaction liquid means the “content (% by mass) of the anhydride of the polyvalent metal salt” obtained by removing water serving as a hydrate. When the content of the polyvalent metal salt in the reaction liquid is excessively large, a deposition amount of the reactant at the non-recording portion of the recording medium may become excessively large. Thus, the image is more liable to be scratched due to abrasion with the back surface of the recording medium having been wound up, with the result that a scratch caused by tightening may be more liable to be generated. Moreover, when a transparent film is used as the recording medium, the transparency of the recording medium may be liable to be lowered.

The reaction liquid containing the organic acid has a buffering capacity in an acidic region (at a pH of less than 7.0, preferably at a pH of from 2.0 to 5.0) to efficiently turn the anionic group of the components present in the ink into an acid type, to thereby aggregate the ink. Examples of the organic acid may include: monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid, and salts thereof, dicarboxylic acids, such as oxalic acid, malonic acid, succinic acid, glutaric acid, adipic acid, maleic acid, fumaric acid, itaconic acid, sebacic acid, phthalic acid, malic acid and tartaric acid, and salts and hydrogen salts thereof, tricarboxylic acids, such as citric acid and trimellitic acid, and salts and hydrogen salts thereof, and tetracarboxylic acids such as pyromellitic acid, and salts and hydrogen salts thereof. When the organic acid is used as the reactant, the content (% by mass) of the organic acid in the reaction liquid is preferably 1.0% by mass or more to 50.0% by mass or less with respect to the total mass of the reaction liquid.

Examples of the cationic resin may include resins having structures of primary to tertiary amines and resins having structures of quaternary ammonium salts. Specific examples thereof may include resins having structures of, for example, vinylamine, allylamine, vinylimidazole, vinylpyridine, dimethylaminoethyl methacrylate, ethylene imine, guanidine, diallyldimethylammonium chloride and an alkylamine-epichlorohydrin condensate. To improve solubility in the reaction liquid, the cationic resin and an acidic compound may be used in combination or the cationic resin may be subjected to quaternization treatment. When the cationic resin is used as the reactant, the content (% by mass) of the cationic resin in the reaction liquid is preferably 0.1% by mass or more to 10.0% by mass or less with respect to the total mass of the reaction liquid.

### [Aqueous Medium]

The reaction liquid is an aqueous reaction liquid containing at least water as an aqueous medium. The reaction liquid may contain water or an aqueous medium that is a mixed solvent of water and a water-soluble organic solvent. It is preferred that deionized water or ion-exchanged water be used as the water. A content (% by mass) of the water-soluble organic solvent in the reaction liquid is preferably 20.0% by mass or less, more preferably 5.0% by mass or less, particularly preferably 1.0% by mass or less based on a total mass of the reaction liquid. Further, it is particularly preferred that the reaction liquid does not contain the water-soluble organic solvent. When the content of the water-soluble organic solvent in the reaction liquid is small, the water-soluble organic solvent may be dried and quickly evaporated at the non-recording portion having only the reaction liquid applied thereto. As a result, it is possible to foster the deposition of the reactant, further facilitating removal of the reactant by air blowing.

A boiling point of the water-soluble organic solvent is preferably 250° C. or less, more preferably 230° C. or less. When the water-soluble organic solvent having a boiling point of 250° C. or less is used, it is possible to evaporate the water-soluble organic solvent more quickly by heating, and the amount of the water-soluble organic solvent remaining in the image can be further reduced, thereby being capable of further improving the blocking resistance of the image. Moreover, it is possible to foster the deposition of the reactant at the non-recording portion having only the reaction liquid applied thereto, further facilitating the removal of the reactant by air blowing. Thus, even when a transparent film is used as the recording medium, the transparency of the recording medium can be effectively prevented from being impaired. It is preferred that the boiling point of the water-soluble organic solvent be 150° C. or more. In particular, when the water-soluble organic solvent having a boiling point of more than 250° C., especially more than 230° C., is used, it is preferred that a content thereof be small. In particular, it is preferred that the reaction liquid not contain the water-soluble organic solvent having a boiling point of more than 250° C., especially more than 230° C.

Preferred specific examples of the water-soluble organic solvent may include ethylene glycol (boiling point: 197° C.), 1,2-propanediol (boiling point: 188° C.), 1,3-propanediol (boiling point: 210° C.), 1,2-butanediol (boiling point: 193° C.), 1,3-butanediol (boiling point: 208° C.), 1,4-butanediol (boiling point: 230° C.), 1,3-butanediol (boiling point: 182° C.), 1,2-pentanediol (boiling point: 206° C.), 1,2-hexanediol (boiling point: 223° C.), 2-methyl-1,3-propanediol (boiling point: 214° C.), diethylene glycol monomethyl ether (boiling point: 194° C.), diethylene glycol monoethyl ether (boiling point: 202° C.), diethylene glycol monoisopropyl ether (boiling point: 207° C.), diethylene glycol monoisobutyl ether (boiling point: 229° C.), diethylene glycol monobutyl ether (boiling point: 230° C.), 1,5-pentanediol (boiling point: 242° C.), diethylene glycol (boiling point: 245° C.) and 2-pyrrolidone (boiling point: 245° C.).

Moreover, it is preferred that a moisture absorption rate of the water-soluble organic solvent be 60% or less. When the water-soluble organic solvent having a moisture absorption rate of 60% or less is used, it is possible to evaporate the water-soluble organic solvent in the reaction liquid more quickly by drying with hot air, thereby being capable of further improving the removal of the reactant that has been deposited. Thus, even when a transparent film is used as the recording medium, the transparency of the recording medium can be effectively prevented from being impaired. Moreover, when the moisture absorption of the water-soluble organic solvent remaining in the image is low, the blocking resistance of the image can be further improved. The moisture absorption rate of the water-soluble organic solvent can be measured and calculated by the following process. First, 2 g of the water-soluble organic solvent is loaded into a petri dish having an outer diameter of 31 mm and a height of 15 mm and is left still for 24 hours under an environment with a temperature of 30° C. and a humidity of 80%. Then, a mass (x (g)) of the water-soluble organic solvent having been left still is measured, and the moisture absorption rate (%) can be calculated with the following formula (1).

Moisture absorption rate (%)={(x−2)/2}×100 (1)

When the water-soluble organic solvent is to be contained in the reaction liquid, it is preferred that, in order to prevent liquid components (water and water-soluble organic solvent) from remaining in the recording medium as much as possible, a water-soluble organic solvent having a boiling point that is not excessively high and a low moisture absorption rate be used. Thus, it is preferred that a water-soluble organic solvent that satisfies both the above-mentioned conditions, that is, properties including a boiling point of 250° C. or less (preferably 230° C. or less) and a moisture absorption rate of 60% or less be used. In particular, even when the water-soluble organic solvent having the above-mentioned properties of the boiling point and the moisture absorption rate is used, it is preferred that the content thereof be small. In this manner, the blocking resistance of the image can be further improved, and even when a transparent film is used as the recording medium, the transparency of the recording medium can be effectively prevented from being impaired. It is preferred that a content (% by mass) of the water-soluble organic solvent having a boiling point of 230° C. or less and a moisture absorption rate of 60% or less in the reaction liquid be 20.0% by mass or less based on a total mass of the reaction liquid. Further, the content is more preferably 5.0% by mass or less, particularly preferably 1.0% by mass or less.

### [Other Component]

The reaction liquid may contain various other components as required. Examples of the other components may include the same examples as those of other components that can be incorporated into the ink to be described later.

### [Physical Properties of Reaction Liquid]

The reaction liquid is an aqueous reaction liquid to be applied to an ink jet system. Accordingly, from the viewpoint of reliability, it is preferred that the physical property values of the reaction liquid be appropriately controlled. Specifically, the surface tension of the reaction liquid at 25° C. is preferably 20 mN/m or more to 60 mN/m or less. The irregularities of the image can be flattened more uniformly by bending the recording medium, thereby being capable of further improving the blocking resistance. Thus, it is more preferred that a surface tension of the reaction liquid be 39 mN/m or less. The surface tension of the reaction liquid can be measured by a plate method. In addition, the viscosity of the reaction liquid at 25° C. is preferably 1.0 mPa·s or more to 10.0 mPa·s or less. The viscosity of the reaction liquid can be measured by a rotary viscometer. The pH of the reaction liquid at 25° C. is preferably 5.0 or more to 9.5 or less, more preferably 6.0 or more to 9.0 or less.

### <Ink>

The ink to be used in the recording method of the present invention is an aqueous ink for ink jet that preferably contains the pigment as the coloring material. Respective components to be used in the ink and the like are described in detail below.

### [Coloring Material]

The ink preferably includes the coloring material. A pigment or a dye may be used as the coloring material. The content (% by mass) of the coloring material in the ink is preferably 0.5% by mass or more to 15.0% by mass or less, more preferably 1.0% by mass or more to 10.0% by mass or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments. The pigments may be used alone or in combination thereof.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Pigments different from each other in dispersion system out of those pigments may be used in combination. Of those, not a resin-bonded pigment or a microcapsule pigment but a resin-dispersed pigment having a resin serving as a dispersant, the resin being caused to physically adsorb to its particle surface, is preferably used.

A dispersant that can disperse the pigment in an aqueous medium through the action of an anionic group is preferably used as a resin dispersant for dispersing the pigment in the aqueous medium. A resin having an anionic group may be used as the resin dispersant and such a resin as described later, in particular, a water-soluble resin is preferably used. The mass ratio of the content (% by mass) of the pigment in the ink to the content (% by mass) of the resin dispersant therein is preferably 0.3 times or more to 10.0 times or less.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

A dye having an anionic group is preferably used as the dye. Specific examples of the dye may include dyes, such as azo, triphenylmethane, (aza)phthalocyanine, xanthene and anthrapyridone dyes. The dyes may be used alone or in combination thereof. The coloring material is preferably a pigment, more preferably a resin-dispersed pigment or a self-dispersible pigment.

### [Resin]

A resin may be incorporated into the ink. The use of the ink including the resin can record an image improved in abrasion resistance. The resin may be added to the ink (i) for stabilizing the dispersed state of the pigment, that is, as a resin dispersant or an aid therefor. In addition, the resin may be added to the ink (ii) for improving the various characteristics of an image to be recorded.

The content (% by mass) of the resin in the ink is preferably 0.1% by mass or more to 20.0% by mass or less, more preferably 0.5% by mass or more to 15.0% by mass or less with respect to the total mass of the ink. Examples of the form of the resin may include a block copolymer, a random copolymer, a graft copolymer and a combination thereof. In addition, the resin may be a water-soluble resin that can be dissolved in an aqueous medium or may be a resin particle to be dispersed in the aqueous medium. The resins may be used alone or in combination thereof.

### [Composition of Resin]

Examples of the resin may include an acrylic resin, a urethane-based resin and an olefin-based resin. Of those, an acrylic resin and a urethane-based resin are preferred and an acrylic resin including a unit derived from (meth)acrylic acid or a (meth)acrylate is more preferred.

A resin having a hydrophilic unit and a hydrophobic unit as its structural units is preferred as the acrylic resin. Of those, a resin having a hydrophilic unit derived from (meth)acrylic acid and a hydrophobic unit derived from at least one of a monomer having an aromatic ring and a (meth)acrylic acid ester-based monomer is preferred. A resin having a hydrophilic unit derived from (meth)acrylic acid and a hydrophobic unit derived from at least one monomer of styrene and α-methylstyrene is particularly preferred. Those resins may each be suitably utilized as a resin dispersant for dispersing the pigment because the resins each easily cause an interaction with the pigment.

The hydrophilic unit is a unit having a hydrophilic group such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Specific examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

The urethane-based resin may be obtained by, for example, causing a polyisocyanate and a polyol to react with each other. In addition, a chain extender may be further caused to react with the reaction product. Examples of the olefin-based resin may include polyethylene and polypropylene.

### [Properties of Resin]

The phrase “resin is water-soluble” as used herein means that when the resin is neutralized with an alkali whose amount is equivalent to its acid value, the resin is present in an aqueous medium under a state in which the resin does not form any particle whose particle diameter may be measured by a dynamic light scattering method. Whether or not the resin is water-soluble can be judged in accordance with the following method. First, a liquid (resin solid content: 10% by mass) containing the resin neutralized with an alkali (e.g., sodium hydroxide or potassium hydroxide) corresponding to its acid value is prepared. Next, the prepared liquid is diluted with pure water tenfold (on a volume basis) to prepare a sample solution. Then, when no particle having a particle diameter is measured at the time of the measurement of the particle diameter of the resin in the sample solution by the dynamic light scattering method, the resin can be judged to be water-soluble. Measurement conditions at this time may be set, for example, as follows: SetZero: 30 seconds; number of times of measurement: 3; and measurement time: 180 seconds. In addition, a particle size analyzer based on the dynamic light scattering method (e.g., an analyzer available under the product name “UPA-EX150” from Nikkiso Co., Ltd.) or the like may be used as a particle size distribution measuring device. Of course, the particle size distribution measuring device to be used, the measurement conditions and the like are not limited to the foregoing.

The acid value of the water-soluble resin is preferably 100 mgKOH/g or more to 250 mgKOH/g or less. The weight-average molecular weight of the water-soluble resin is preferably 3,000 or more to 15,000 or less.

The acid value of a resin for forming the resin particle is preferably 5 mgKOH/g or more to 100 mgKOH/g or less. The weight-average molecular weight of the resin for forming the resin particle is preferably 1,000 or more to 3,000,000 or less, more preferably 100,000 or more to 3,000,000 or less. The volume-based 50% cumulative particle diameter (D₅₀) of the resin particle measured by a dynamic light scattering method is preferably 50 nm or more to 500 nm or less. The volume-based 50% cumulative particle diameter of the resin particle is the diameter of the particle in a particle diameter cumulative curve at which the ratio of the particle integrated from small particle diameters reaches 50% with respect to the total volume of the measured particle. The volume-based 50% cumulative particle diameter of the resin particle may be measured with the above-mentioned particle size analyzer of a dynamic light scattering system and under the above-mentioned measurement conditions.

It is preferred that the ink contain a resin particle. The strength of the image is increased by softening the resin particle by heating. Thus, the blocking resistance of the image is further improved, and irregularities of an image layer formed of a pigment are reduced. In this manner, it is possible to reduce the irregularities on the image surface subjected to recording, thereby being capable of preventing generation of a scratch caused by tightening more effectively. It is preferred that a content (% by mass) of the resin particle in the ink be 5.0% by mass or more to 20.0% by mass or less based on a total mass of the ink. When the content of the resin particle is less than 5.0% by mass, the strength of the image may be lowered, with the result that a scratch caused by tightening may be more liable to be generated. Meanwhile, when the content of the resin particle is more than 20.0% by mass, the stability in ejection of the ink may be somewhat lowered. It is preferred that a glass transition temperature of the resin particle be 40° C. or more and be equal to or less than a surface temperature of the recording medium heated in the drying step because the blocking resistance of the image is further improved. Specifically, the glass transition temperature of the resin particle is preferably 120° C. or less, more preferably 100° C. or less. The glass transition temperature (° C.) of the resin particle can be measured with use of a differential scanning calorimeter (DSC).

### [Wax Particle]

A particle formed of a wax (wax particle) may be incorporated into the ink. The use of the ink including the wax particle can record an image further improved in abrasion resistance. The wax in this specification may be a composition blended with a component except the wax or may be the wax itself. The wax particle may be dispersed with a dispersant, such as a surfactant or a resin. The waxes may be used alone or in combination thereof. The content (% by mass) of the wax particle in the ink is preferably 0.1% by mass or more to 10.0% by mass or less, more preferably 1.0% by mass or more to 5.0% by mass or less with respect to the total mass of the ink.

The wax is an ester of a higher monohydric or dihydric alcohol that is insoluble in water and a fatty acid in a narrow sense. Accordingly, animal-based waxes and plant-based waxes are included in the category of the wax but oils and fats are not included therein. High-melting point fats, mineral-based waxes, petroleum-based waxes and blends and modified products of various waxes are included therein in a broad sense. In the present invention, the waxes in a broad sense may each be used without any particular limitation. The waxes in a broad sense may be classified into natural waxes, synthetic waxes, blends thereof (blended waxes) and modified products thereof (modified waxes).

Examples of the natural wax may include: animal-based waxes, such as beeswax, a spermaceti wax and lanolin; plant-based waxes, such as a Japan wax, a carnauba wax, a sugar cane wax, a palm wax, a candelilla wax and a rice wax; mineral-based waxes such as a montan wax; and petroleum-based waxes, such as a paraffin wax, a microcrystalline wax and petrolatum. Examples of the synthetic wax may include hydrocarbon-based waxes, such as a Fischer-Tropsch wax and polyolefin waxes (e.g., polyethylene wax and polypropylene wax). The blended waxes are mixtures of the above-mentioned various waxes. The modified waxes are obtained by subjecting the above-mentioned various waxes to modification treatment, such as oxidation, hydrogenation, alcohol modification, acrylic modification or urethane modification. The above-mentioned waxes may be used alone or in combination thereof. The wax is preferably at least one kind selected from the group consisting of: a microcrystalline wax; a Fischer-Tropsch wax; a polyolefin wax; a paraffin wax; and modified products and blends thereof. Of those, a blend of a plurality of kinds of waxes is more preferred and a blend of a petroleum-based wax and a synthetic wax is particularly preferred.

The wax is preferably a solid at normal temperature (25° C.). The melting point (° C.) of the wax is preferably 40° C. or more to 120° C. or less, more preferably 50° C. or more to 100° C. or less. The melting point of the wax may be measured in conformity with a test method described in the section 5.3.1 (Melting Point Testing Method) of JIS K 2235:1991 (Petroleum Waxes). In the cases of a microcrystalline wax, petrolatum and a mixture of a plurality of kinds of waxes, their melting points may be measured with higher accuracy by utilizing a test method described in the section 5.3.2 thereof. The melting point of the wax is susceptible to characteristics, such as a molecular weight (a larger molecular weight provides a higher melting point), a molecular structure (a linear structure provides a higher melting point but a branched structure provides a lower melting point), crystallinity (higher crystallinity provides a higher melting point) and a density (a higher density provides a higher melting point). Accordingly, the control of those characteristics can provide a wax having a desired melting point. The melting point of the wax in the ink may be measured, for example, as follows: after the wax fractionated by subjecting the ink to ultracentrifugation treatment has been washed and dried, its melting point is measured in conformity with each of the above-mentioned test methods.

### [Aqueous Medium]

The ink to be used in the recording method of the present invention is an aqueous ink including at least water as an aqueous medium. An aqueous medium that is the water or a mixed solvent of the water and a water-soluble organic solvent may be incorporated into the ink. Deionized water or ion-exchanged water is preferably used as the water. The content (% by mass) of the water in the aqueous ink is preferably 50.0% by mass or more to 95.0% by mass or less with respect to the total mass of the ink. In addition, the content (% by mass) of the water-soluble organic solvent in the aqueous ink is preferably 2.0% by mass or more to 40.0% by mass or less with respect to the total mass of the ink. Solvents that may be used in an ink for ink jet, such as alcohols, (poly)alkylene glycols, glycol ethers, nitrogen-containing solvents and sulfur-containing solvents, may each be used as the water-soluble organic solvent. The water-soluble organic solvents may be used alone or in combination thereof.

A boiling point of the water-soluble organic solvent is preferably 250° C. or less, more preferably 230° C. or less. When the water-soluble organic solvent having a boiling point of 250° C. or less is used, it is possible to evaporate the water-soluble organic solvent more quickly by heating. When the boiling point of the water-soluble organic solvent is more than 250° C., the water-soluble organic solvent is more liable to remain in an image to be formed and is more liable to absorb a water content in the air. As a result, the blocking is somewhat more liable to occur, and a friction coefficient of the image surface may be increased, with the result that a scratch caused by tightening may be somewhat more liable to be generated.

### [Other Component]

The ink may include various other components as required. Examples of other components may include various additives, such as an antifoaming agent, a surfactant, a pH adjustor, a viscosity modifier, a rust inhibitor, an antiseptic, a fungicide, an antioxidant and an anti-reducing agent. However, the ink is preferably free of the reactant to be incorporated into the reaction liquid.

### [Physical Properties of Ink]

The ink is an aqueous ink to be applied to an ink jet system. Accordingly, from the viewpoint of reliability, it is preferred that the physical property values of the ink be appropriately controlled. Specifically, the surface tension of the ink at 25° C. is preferably 20 mN/m or more to 60 mN/m or less. The irregularities of the image can be flattened more uniformly by bending the recording medium, thereby being capable of further improving the blocking resistance. Thus, it is more preferred that a surface tension of the ink be 39 mN/m or less. The surface tension of the ink can be measured by a plate method. In addition, the viscosity of the ink at 25° C. is preferably 1.0 mPa·s or more to 10.0 mPa·s or less. The irregularities of the image can be flattened more uniformly by bending the recording medium, thereby being capable of further improving the blocking resistance. Thus, it is more preferred that a viscosity of the ink be 7.0 mPa·s or less. The viscosity of the ink may be measured with a viscometer of a rotary type. The pH of the ink at 25° C. is preferably 7.0 or more to 9.5 or less, more preferably 8.0 or more to 9.5 or less.

In the recording method of the present invention using a reaction liquid and an ink, the reaction liquid and the ink come into contact with each other on the recording medium to increase the viscosity, and an image is recorded. A viscosity of a mixed liquid of the ink and the reaction liquid affects an image to be recorded. Thus, it is preferred that the viscosity of the mixed liquid fall within an appropriate range. The viscosity of the mixed liquid varies in accordance with a mass ratio given when the ink and the reaction liquid are mixed with each other. In the present invention, it is preferred that the reaction liquid be used in a ratio within the range of 0.08 part by mass or more to 0.40 part by mass or less with respect to 1.00 part by mass of the ink. Further, it is preferred that a ratio of a viscosity (mPa·s) of a mixed liquid obtained by mixing 1.00 part by mass of the ink and the reaction liquid within the range of 0.08 part by mass or more to 0.40 part by mass or less at 25° C. with respect to a viscosity (mPa·s) of the ink at 25° C. be 10 times or more to 100 times or less. When the ratio described above is 10 times or more, the uniformity of an image to be recorded may be further improved. Moreover, when the ratio described above is 100 times or less, it is possible to flatten the irregularities of the image more uniformly by bending the recording medium, thereby being capable of further improving the blocking resistance.

### Examples

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

### <Preparation of Reaction Liquid>

Respective components (unit: %) shown in the upper sections of Table 1-1 to Table 1-3 were mixed and sufficiently stirred, followed by filtration with a cellulose acetate filter having a pore size of 3.0 m (manufactured by Advantec) under pressure. Thus, respective reaction liquids were prepared. In Table 1-1 to Table 1-3, “SHALLOL DC902P” is a product name of a cationic resin manufactured by DKS Co. Ltd., and “ACETYLENOL E100” is a product name of a surfactant manufactured by Kawaken Fine Chemicals Co., Ltd. In the lower sections of Table 1-1 to Table 1-3, properties of the reaction liquids are shown. The surface tension of the reaction liquid was measured with use of an automatic surface tensiometer (product name “DY-300”, manufactured by Kyowa Interface Science Co., Ltd.).

TABLE 1-1
Composition and property of the reaction liquids

| | Reaction liquid | | | | | | | |
|---|---|---|---|---|---|---|---|---|
| | 1 | 2 | 3 | 4 | 5 | 6 | 7 | 8 |
| Magnesium sulfate heptahydrate | 10.0 | | | | | | | |
| (Solubility in water: 25%) | | | | | | | | |
| Calcium succinate trihydrate | | 1.0 | | | | | | |
| (Solubility in water: 1.3%) | | | | | | | | |
| Barium nitrate (Solubility in water: 8%) | | | 6.0 | | | | | |
| Aluminum sulfate hexadecahydrate | | | | 10.0 | | | | |
| (Solubility in water: 28%) | | | | | | | | |
| Magnesium acetate tetrahydrate | | | | | 10.0 | | | |
| (Solubility in water: 32%) | | | | | | | | |
| Aluminum nitrate nonahydrate | | | | | | 10.0 | | |
| (Solubility in water: 43%) | | | | | | | | |
| Calcium nitrate tetrahydrate | | | | | | | 10.0 | |
| (Solubility in water: 56%) | | | | | | | | |
| Sharol DC902P | | | | | | | | 10.0 |
| 1,2-Propanediol (Boiling point: 188° C., | 1.0 | 1.0 | 1.0 | 1.0 | 1.0 | 1.0 | 1.0 | 1.0 |
| Moisture absorption: 59%) | | | | | | | | |
| 1,2-Butanediol (Boiling point: 193° C., Moisture | | | | | | | | |
| absorption: 40%) | | | | | | | | |
| 1,2-Pentanediol (Boiling point: 206° C., | | | | | | | | |
| Moisture absorption: 24%) | | | | | | | | |
| 2-Pyrrolidone (Boiling point: 245° C., Moisture | | | | | | | | |
| absorption: 65%) | | | | | | | | |
| Glycerin (Boiling point: 290° C., Moisture | | | | | | | | |
| absorption: 70%) | | | | | | | | |
| Acetylenol E100 | 0.3 | 0.3 | 0.3 | 0.3 | 0.3 | 0.3 | 0.3 | 0.3 |
| Ion-exchanged water | 88.7 | 97.7 | 92.7 | 88.7 | 88.7 | 88.7 | 88.7 | 88.7 |
| Content of polyvalent metal salts in water (%) | 4.9 | 0.7 | 6.0 | 5.4 | 6.6 | 5.7 | 6.9 | 0.0 |
| Content of water-soluble organic solvents with | 1.0 | 1.0 | 1.0 | 1.0 | 1.0 | 1.0 | 1.0 | 1.0 |
| a moisture absorption ratio of 60% or less (%) | | | | | | | | |
| Surface tension (mN/m) | 33 | 33 | 33 | 33 | 33 | 33 | 33 | 33 |

TABLE 1-2
Composition and property of the reaction liquids

| | Reaction liquid | | | | | | | |
|---|---|---|---|---|---|---|---|---|
| | 9 | 10 | 11 | 12 | 13 | 14 | 15 | 16 |
| Magnesium sulfate heptahydrate | 10.0 | 20.5 | 25.0 | 10.0 | 20.0 | 20.0 | 20.0 | 10.0 |
| (Solubility in water: 25%) | | | | | | | | |
| Calcium succinate trihydrate | | | | | | | | |
| (Solubility in water: 1.3%) | | | | | | | | |
| Barium nitrate (Solubility in water: 8%) | | | | | | | | |
| Aluminum sulfate hexadecahydrate | | | | | | | | |
| (Solubility in water: 28%) | | | | | | | | |
| Magnesium acetate tetrahydrate | | | | | | | | |
| (Solubility in water: 32%) | | | | | | | | |
| Aluminum nitrate nonahydrate | | | | | | | | |
| (Solubility in water: 43%) | | | | | | | | |
| Calcium nitrate tetrahydrate | | | | | | | | |
| (Solubility in water: 56%) | | | | | | | | |
| Sharol DC902P | 3.0 | | | | | | | |
| 1,2-Propanediol (Boiling point: 188° C., | 1.0 | 1.0 | 1.0 | | | | | |
| Moisture absorption: 59%) | | | | | | | | |
| 1,2-Butanediol (Boiling point: 193° C., Moisture | | | | | 10.0 | | | |
| absorption: 40%) | | | | | | | | |
| 1,2-Pentanediol (Boiling point: 206° C., | | | | | | 10.0 | | |
| Moisture absorption: 24%) | | | | | | | | |
| 2-Pyrrolidone (Boiling point: 245° C., Moisture | | | | | | | 10.0 | |
| absorption: 65%) | | | | | | | | |
| Glycerin (Boiling point: 290° C., Moisture | | | | | | | | 10.0 |
| absorption: 70%) | | | | | | | | |
| Acetylenol E100 | 0.3 | 0.3 | 0.3 | 0.3 | 0.3 | 0.3 | 0.3 | 0.3 |
| Ion-exchanged water | 85.7 | 78.2 | 73.7 | 89.7 | 69.7 | 69.7 | 69.7 | 79.7 |
| Content of polyvalent metal salts in water (%) | 4.9 | 10.0 | 12.2 | 4.9 | 9.8 | 9.8 | 9.8 | 4.9 |
| Content of water-soluble organic solvents with | 1.0 | 1.0 | 1.0 | 0.0 | 10.0 | 10.0 | 0.0 | 0.0 |
| a moisture absorption ratio of 60% or less (%) | | | | | | | | |
| Surface tension (mN/m) | 33 | 33 | 33 | 33 | 35 | 35 | 35 | 35 |

TABLE 1-3
Composition and property of the reaction liquids

| | Reaction liquid | | | | | | |
|---|---|---|---|---|---|---|---|
| | 17 | 18 | 19 | 20 | 21 | 22 | 23 |
| Magnesium sulfate heptahydrate | 20.0 | 20.0 | 20.0 | 20.0 | 10.0 | 10.0 | |
| (Solubility in water: 25%) | | | | | | | |
| Calcium succinate trihydrate | | | | | | | |
| (Solubility in water: 1.3%) | | | | | | | |
| Barium nitrate (Solubility in water: 8%) | | | | | | | |
| Aluminum sulfate hexadecahydrate | | | | | | | |
| (Solubility in water: 28%) | | | | | | | |
| Magnesium acetate tetrahydrate | | | | | | | 16.0 |
| (Solubility in water: 32%) | | | | | | | |
| Aluminum nitrate nonahydrate | | | | | | | |
| (Solubility in water: 43%) | | | | | | | |
| Calcium nitrate tetrahydrate | | | | | | | |
| (Solubility in water: 56%) | | | | | | | |
| Sharol DC902P | | | | | | | |
| 1,2-Propanediol (Boiling point: 188° C., | 5.0 | 6.0 | 20.0 | 25.0 | 1.0 | 1.0 | 5.0 |
| Moisture absorption: 59%) | | | | | | | |
| 1,2-Butanediol (Boiling point: 193°° C., Moisture | | | | | | | |
| absorption: 40%) | | | | | | | |
| 1,2-Pentanediol (Boiling point: 206° C., | | | | | | | |
| Moisture absorption: 24%) | | | | | | | |
| 2-Pyrrolidone (Boiling point: 245° C., Moisture | | | | | | | |
| absorption: 65%) | | | | | | | |
| Glycerin (Boiling point: 290° C., Moisture | | | | | | | 5.0 |
| absorption: 70%) | | | | | | | |
| Acetylenol E100 | 0.3 | 0.3 | 0.3 | 0.3 | 0.06 | 0.05 | 0.3 |
| Ion-exchanged water | 74.7 | 73.7 | 59.7 | 54.7 | 88.94 | 88.95 | 73.7 |
| Content of polyvalent metal salts in water (%) | 9.8 | 9.8 | 9.8 | 9.8 | 4.9 | 4.9 | 10.6 |
| Content of water-soluble organic solvents with | 5.0 | 6.0 | 20.0 | 25.0 | 1.0 | 1.0 | 5.0 |
| a moisture absorption ratio of 60% or less (%) | | | | | | | |
| Surface tension (mN/m) | 34 | 34 | 36 | 36 | 39 | 40 | 34 |

### <Preparation of Pigment Dispersion Liquid>

### (Pigment Dispersion Liquid 1)

A styrene-ethyl acrylate-acrylic acid copolymer (resin 1) having an acid value of 150 mgKOH/g and a weight average molecular weight of 8,000 was prepared. 20.0 parts of the resin 1 was neutralized with potassium hydroxide equimolar to the acid value of the resin 1, and then an appropriate amount of pure water was added, whereby an aqueous solution of the resin 1 having a content of the resin (solid content) of 20.0% was prepared. 15.0 parts of a pigment (carbon black), 22.5 parts of the aqueous solution of the resin 1 and 62.5 parts of pure water were mixed to obtain a mixture. The obtained mixture and 200 parts of zirconia beads having a diameter of 0.3 mm were put in a batch type vertical sand mill (manufactured by IMEX Co., Ltd.) and dispersed for 5 hours while cooling with water. After a coarse particle was removed by centrifugation, the mixture was filtered through a cellulose acetate filter having a pore size of 3.0 μm (manufactured by ADVANTEC CO., LTD.) under pressure to prepare a pigment dispersion liquid 1 having a content of the pigment of 15.0% and a content of the resin dispersant (resin 1) of 4.5%.

### (Pigment Dispersion Liquid 2)

A pigment dispersion liquid 2 having a pigment content of 15.0% and a resin dispersant (Resin 1) content of 4.5% was prepared by the same procedure as that of the above-mentioned pigment dispersion liquid 1 except that the pigment was changed to C.I. Pigment Blue 15:3.

### (Pigment Dispersion Liquid 3)

A pigment dispersion liquid 3 having a pigment content of 15.0% and a resin dispersant (Resin 1) content of 4.5% was prepared by the same procedure as that of the above-mentioned pigment dispersion liquid 1 except that the pigment was changed to C.I. Pigment Red 122.

### (Pigment Dispersion Liquid 4)

A pigment dispersion liquid 4 having a pigment content of 15.0% and a resin dispersant (Resin 1) content of 4.5% was prepared by the same procedure as that of the above-mentioned pigment dispersion liquid 1 except that the pigment was changed to C.I. Pigment Yellow 74.

### (Pigment Dispersion Liquid 5)

A solution obtained by dissolving 5.0 g of concentrated hydrochloric acid in 5.5 g of water was brought into the state of being cooled to 5° C., followed by the addition of 1.8 g of 4-aminophthalic acid to the solution. A container containing the solution was loaded into an ice bath, and while the solution was stirred so that its temperature was held at 10° C. or less, a solution obtained by dissolving 0.9 g of sodium nitrite in 9.0 g of ion-exchanged water at 5° C. was added thereto. After the mixture had been stirred for 15 minutes, 6.0 g of carbon black was added to the mixture under stirring and the whole was further stirred for 15 minutes to provide a slurry. The resultant slurry was filtered with filter paper (product name: “STANDARD FILTER PAPER No. 2,” manufactured by Advantec), and particles remaining on the filter paper were sufficiently washed with water and dried in an oven at 110° C. After that, a sodium ion was substituted with a potassium ion by an ion exchange method. Thus, a self-dispersion pigment in which a —C₆H3-(COOK)₂ group was bonded to the particle surface of the carbon black was obtained. An appropriate amount of pure water was added to adjust the content of the pigment. Thus, a pigment dispersion liquid 5 in which the content of the pigment was 15.0% was obtained.

### <Preparation of Resin Particle>

74.0 Parts of ion-exchanged water and 0.2 part of potassium persulfate were loaded into a four-necked flask including a stirrer, a reflux condenser and a nitrogen gas introduction pipe, followed by mixing. In addition, predetermined amounts of 2-ethylhexyl methacrylate and methacrylic acid, and 0.3 part of a reactive surfactant (product name “ADEKA REASOAP ER-20”, manufactured by Adeka Corporation) were mixed to prepare an emulsion. The usage amounts of 2-ethylhexyl methacrylate and methacrylic acid were adjusted such that the resin particles 1 to 3 had glass transition temperatures of 70° C., 40° C. and 35° C., respectively. Under a nitrogen atmosphere, the prepared emulsion was dropped into the above-mentioned four-necked flask over 1 hour and was subjected to a polymerization reaction for 2 hours while the mixture was stirred at 80° C. After the resultant had been cooled to 25° C., ion-exchanged water and an aqueous solution containing potassium hydroxide whose molar amount was equivalent to the acid value of a resin particle were added. Thus, a water dispersion liquid of each resin particle in which the content of the resin particle (solid content) was 40.0% was prepared.

### <Preparation of Ink>

Respective components (unit: %) shown in the upper column of Table 2-1 and Table 2-2 were mixed and sufficiently stirred, followed by filtration with a cellulose acetate filter having a pore size of 3.0 m (manufactured by Advantec) under pressure. Thus, respective inks were prepared. The term “Acetylenol E100” shown in Table 2-1 and Table 2-2 is the product name of a surfactant manufactured by Kawaken Fine Chemicals Co., Ltd. The bottom column of Table 2-1 and Table 2-2 shows the characteristics of the inks. The surface tension of the ink was measured using an automatic surface tensiometer (Product name: DY-300, manufactured by Kyowa Interface Science Co., Ltd.).

TABLE 2-1
Composition and properties of the inks

| | Ink | | | | | | | |
|---|---|---|---|---|---|---|---|---|
| | 1 | 2 | 3 | 4 | 5 | 6 | 7 | 8 |
| Pigment dispersion liquid 1 | 20.0 | | | | | 20.0 | 20.0 | 20.0 |
| Pigment dispersion liquid 2 | | 20.0 | | | | | | |
| Pigment dispersion liquid 3 | | | 20.0 | | | | | |
| Pigment dispersion liquid 4 | | | | 20.0 | | | | |
| Pigment dispersion liquid 5 | | | | | 20.0 | | | |
| Water dispersion liquid of Resin particle 1 | 20.0 | 20.0 | 20.0 | 20.0 | 20.0 | 20.0 | 20.0 | |
| Water dispersion liquid of Resin particle 2 | | | | | | | | |
| Water dispersion liquid of Resin particle 3 | | | | | | | | |
| 1,2-Propanediol (Boiling point: 188° C.) | 15.0 | 15.0 | 15.0 | 15.0 | 15.0 | | | 15.0 |
| 2-Pyrrolidone (Boiling point: 245° C.) | | | | | | 15.0 | | |
| Glycerin (Boiling point: 290° C.) | | | | | | | 15.0 | |
| Acetylenol E100 | 1.00 | 1.00 | 1.00 | 1.00 | 1.00 | 1.00 | 1.00 | 1.00 |
| Ion-exchanged water | 44.0 | 44.0 | 44.0 | 44.0 | 44.0 | 44.0 | 44.0 | 64.0 |
| Content of resin particles (% ) | 8.0 | 8.0 | 8.0 | 8.0 | 8.0 | 8.0 | 8.0 | 0.0 |
| Surface tension (mN/m) | 33 | 33 | 33 | 33 | 33 | 33 | 33 | 33 |

TABLE 2-2
Composition and properties of the inks

| | Ink | | | | | | |
|---|---|---|---|---|---|---|---|
| | 9 | 10 | 11 | 12 | 13 | 14 | 15 |
| Pigment dispersion liquid 1 | 20.0 | 20.0 | 20.0 | 20.0 | 20.0 | 20.0 | 20.0 |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | | | | | | |
| Water dispersion liquid of Resin particle 1 | | | 10.0 | 12.5 | 20.0 | 20.0 | |
| Water dispersion liquid of Resin particle 2 | 20.0 | | | | | | |
| Water dispersion liquid of Resin particle 3 | | 20.0 | | | | | |
| 1,2-Propanediol (Boiling point: 188° C.) | 15.0 | 15.0 | 15.0 | 15.0 | 15.0 | 15.0 | |
| 2-Pyrrolidone (Boiling point: 245° C.) | | | | | | | |
| Glycerin (Boiling point: 290° C.) | | | | | | | 15.0 |
| Acetylenol E100 | 1.00 | 1.00 | 1.00 | 1.00 | 0.15 | 0.10 | 1.00 |
| Ion-exchanged water | 44.0 | 44.0 | 54.0 | 51.5 | 44.9 | 44.9 | 64.0 |
| Content of resin particles (% ) | 8.0 | 8.0 | 4.0 | 5.0 | 8.0 | 8.0 | 0.0 |
| Surface tension (mN/m) | 33 | 33 | 33 | 33 | 39 | 40 | 33 |

### <Preparation of Recording Medium>

As recording mediums, five kinds of rolls of recording mediums described below and a recording medium obtained by cutting the rolls of a recording medium into a predetermined size were used. A PET film and a PP film are both a label sheet integrated with release paper.
Recording medium 1 (non-absorbable): PET film, product name “PETWH50 PAT8LK”, Lintec Corporation, water absorption amount: less than 2.5 mL/m²
Recording medium 2 (absorbable): high-quality paper, product name “55 PW 8k”, Lintec Corporation, water absorption amount: 10.2 mL/m²
Recording medium 3 (low-absorbability): art paper, product name “Gloss PW8k”, Lintec Corporation, water absorption amount: 5.5 mL/m²
Recording medium 4 (non-absorbable): PP film, product name “OPP50C PAT1E8LK”, Lintec Corporation, water absorption amount: less than 2.5 mL/m²
Recording medium 5 (non-absorbable): aluminum, product name “Arumitantai 50 PAT1 8EA”, Lintec Corporation, water absorption amount: less than 2.5 mL/m²
Recording medium 6: recording medium obtained by cutting the recording medium 1 into A4 size

### <Evaluation>

The reaction liquids and the inks in the combinations shown in Table 5-1 to Table 5-5 were given as sets. With regard to the reaction liquid and the ink forming each set, the viscosity of the mixed liquid was measured by the process described below, and a ratio of the viscosity of the mixed liquid with respect to the viscosity of the ink was calculated. First, the reaction liquid and the ink were mixed with each other based on the “reaction liquid/ink mixture mass ratio (times)” shown in Table 4 and were stirred for 1 minute, thereby preparing a mixed liquid. Then, the viscosity (mPa·s) of the mixed liquid having been prepared was measured with use of an E-type viscometer (product name “RE80-L”, manufactured by Toki Sangyo Co., Ltd.) that circulates antifreeze, via a tube, to a thermostatic chamber set to 25° C. Further, a value of a ratio (mixed viscosity (times)) with respect to the viscosity (mPa·s) of a corresponding ink at 25° C. was calculated. Results are shown in Table 5-1 to Table 5-5. The reaction liquid and the ink forming a set were loaded respectively into a reaction-liquid applying device 1201 and an ink applying device 1202 of the ink jet recording apparatus having the configuration shown in Table 3. In this ink jet recording apparatus, an image recorded under a condition that one ink droplet of 3.0 ng is applied to a unit area of 1/1,200 inches× 1/1,200 inches is defined as having a recording duty of 100%.

TABLE 3
Conditions of the recording device

| | | | | Bending process | | | Fixing process | | |
|---|---|---|---|---|---|---|---|---|---|
| | | | | Orientation of | | | Fixing | | Orientation |
| | | Recording process | | recording | | | process | | of recording |
| | | Number of | Heating in | surface of | Bending | Bending | after | | surface at |
| Recording | FIG. of | recording | recording | bending | angle | radius | heating | Pressure | the time of |
| apparatus | device | paths | process | process | α (°) | β (cm) | process | (Pa) | winding |
| 1 | 1A | 1pass | None | Outside | 90 | 10 | Yes | 40 | Outside |
| 2 | 1A | 1pass | Yes | Outside | 90 | 10 | Yes | 40 | Outside |
| 3 | 1C | 1pass | None | Outside | 90 | 10 | Yes | 40 | Inside |
| 4 | 1D | 1pass | None | None | — | — | Yes | 40 | Outside |
| 5 | 1B | 1pass | None | Inside | −90 | 10 | Yes | 40 | Outside |
| 6 | 1A | 1pass | None | Outside | 70 | 10 | Yes | 40 | Outside |
| 7 | 1A | 1pass | None | Outside | 80 | 10 | Yes | 40 | Outside |
| 8 | 1A | 1pass | None | Outside | 100 | 10 | Yes | 40 | Outside |
| 9 | 1A | 1pass | None | Outside | 90 | 5 | Yes | 40 | Outside |
| 10 | 1A | 1pass | None | Outside | 90 | 20 | Yes | 40 | Outside |
| 11 | 1A | 1pass | None | Outside | 90 | 25 | Yes | 40 | Outside |
| 12 | 1E | 1pass | None | Outside | 90 | 10 | None | — | Outside |
| 13 | 1A | 1pass | None | Outside | 90 | 10 | Yes | 20 | Outside |
| 14 | 1A | 1pass | None | Outside | 90 | 10 | Yes | 30 | Outside |
| 15 | 1A | 1pass | None | Outside | 90 | 10 | Yes | 100 | Outside |
| 16 | 1F | 1pass | Yes | Inside | −70 | 25 | None | — | Inside |
| 17 | 1D | 1pass | None | None | — | — | Yes | 40 | — |
| 18 | 1D | Multipass | None | None | — | — | Yes | 40 | Outside |

TABLE 4
Recording condition

| | | | Mixed mass | Heating | |
|---|---|---|---|---|---|
| | Recording | Recording | ratio of | temperature | Re- |
| | duty | duty of | reaction | of fixing | cording |
| Recording | of ink | reaction | liquid/ | process | speed |
| condition | (%) | liquid (%) | ink (times) | (° C.) | (m/min) |
| 1 | 100 | 10 | 0.10 | 80 | 20 |
| 2 | 100 | 10 | 0.10 | 59 | 20 |
| 3 | 100 | 10 | 0.10 | 60 | 20 |
| 4 | 100 | 10 | 0.10 | 100 | 20 |
| 1 | 100 | 10 | 0.10 | 80 | 20 |
| 5 | 100 | 45 | 0.45 | 80 | 20 |
| 6 | 100 | 40 | 0.40 | 80 | 20 |
| 7 | 100 | 8 | 0.08 | 80 | 20 |
| 8 | 100 | 7 | 0.07 | 80 | 20 |
| 9 | 100 | 10 | 0.10 | 80 | 4 |
| 10 | 100 | 10 | 0.10 | 80 | 5 |
| 11 | 100 | 10 | 0.10 | 80 | 100 |
| 12 | 100 | 10 | 0.10 | 80 | 101 |
| 13 | 100 | 45 | 0.45 | — | 101 |

With use of the ink jet recording apparatus having the configuration described above, while the recording medium was conveyed, two kinds of solid images described below were recorded on the recording medium in accordance with recording conditions shown in Table 4 and evaluation conditions shown in Table 5-1 to Table 5-5. The two kinds of images were repeatedly recorded on the recording medium of 1,000 m at intervals of 1 cm in a conveyance direction. After that, in the wind-up portion, the recording medium was wound up into a roll with a tension of 15 MPa. The recording medium having been wound up into a roll was kept for 24 hours under the conditions of a temperature of 23° C. and a relative humidity of 50% in a state of having a tension applied thereto. After the recording medium has been kept, the tension on the recording medium having been wound up was released. Then, a part of the recording medium located at a position of 500 m from a distal end of the recording medium having been wound up was taken out, and an evaluation of each of the following items was performed. In the present invention, in the evaluation criteria of each of the following items, “AA”, “A” and “B” were defined as acceptable levels, and “C” was defined as an unacceptable level. Evaluation results are shown in Table 6-1 to Table 6-3.
Solid image of 15 cm×15 cm, with a recording duty of the reaction liquid being 25% and a recording duty of the ink being 100%
Solid image of 15 cm×15 cm, with only the reaction liquid applied with a recording duty of 25%

In Examples 14 and 72, an ink jet recording apparatus provided with a cooling portion employing such a system of being brought into contact with a cooling roll of a water-cooled type was used. In Example 20 and Reference Examples 1 and 2, an ink jet recording apparatus that performs drying by heating under a state in which the recording face of the recording medium faces upward, as illustrated in FIG. 1D, was used. In Comparative Examples 2 and 4 to 11, an image was recorded while a cooling function of the cooling member was in an OFF state. In Comparative Example 2, an image was recorded while a function of a heating device was in an OFF state. In Comparative Example 12, an image was recorded while a cooling function of a cooling member was in an OFF state, and after that, a conveyance distance was adjusted such that the temperature was decreased to a predetermined temperature by natural heat radiation in a period from the passage of the recording medium through the heating device up to winding up of the recording medium. Thus, it took the time of more than 5 seconds after the end of the drying step to cool the recording medium to 35° C.

In Reference Example 1, a recording medium having been cut into a predetermined size was used. After an image was recorded on the recording medium by the amount corresponding to 1,000 m as in Example 1, the recording mediums were delivered to a sheet delivery portion (not shown) such that the recording medium were stacked. Then, a load was applied to the stacked recorded items such that a force equivalent to 15 MPa being a tension for winding up the roll paper was applied, and the recorded items were kept for 24 hours under the conditions of a temperature of 23° C. and a relative humidity of 50%. After that, an evaluation described later was performed on the recorded item located at a position corresponding to a half of the number of recorded items. Further, in Reference Example 2, after the reaction liquid and the ink were applied to the recording medium, the recording medium was conveyed in a reverse direction, and was conveyed again in a forward direction after the recording medium had passed through the recording portion, thereby applying the reaction liquid and the ink again. Multi-pass recording was performed by repeating the above-mentioned operation two times in total to apply the reaction liquid and the ink three times in total separately so that the total application amount of the reaction liquid achieved 8% duty and the total application amount of the ink achieved 100% duty. In Reference Example 2, the time taken for performing the recording on the amount equivalent to that of Example 1 was very long.

### (Blocking Resistance)

A state of an image located at the position of 500 m from the distal end of the recording medium having been wound up and a state of the back surface of the recording medium with which the image was in contact were visually observed, and the blocking resistance was evaluated based on the evaluation criteria described below.
AA: No damage was found in the image.
A: Removal of more than 0% to less than 1% on an area basis was found in the image, but the ink did not adhere to the back surface of the recording medium.
B: Removal of 1% or more to less than 5% on an area basis was found in the image, and the ink adhered to the back surface of the recording medium.
C: Removal of 5% or more on an area basis was found in the image, and the ink adhered to the back surface of the recording medium.

### (Scratch Caused by Tightening)

The image located at the position of 500 m from the distal end of the recording medium having been wound up was observed with use of a magnifying lens with a magnification of 50×, and a scratch caused by tightening was evaluated based on evaluation criteria described below.
AA: No scratch was found even when the magnification lens of 50× was used.
A: No scratch was found by visual inspection, but a linear scratch was found when the magnification lens of 50× was used.
B: A linear scratch was found only at a part of the image by visual inspection.
C: A linear scratch was found throughout the image by visual inspection.

### (Warpage of Recording Medium)

The recording medium was cut into A4 size from the position of 500 mm from the distal end of the recording medium having been wound up, and was placed horizontally on a flat surface with the recorded image facing upward. Then, the amount of rising from the flat surface at four sides was measured under the conditions of a temperature of 23° C. and a humidity of 50%, and warpage of the recording medium was evaluated based on evaluation criteria described below.
A: The maximum rising amount was less than 1 cm.
B: The maximum rising amount was 1 cm or more to less than 3 cm.
C: The maximum rising amount was 3 cm or more.

### (Uniformity)

The recording medium was cut into A4 size from the position of 500 mm from the distal end of the recording medium having been wound up, and a scanner (product name “OFFIRIO ES-10000G”, manufactured by Seiko Epson Corporation) was used to capture an image recorded under the conditions of a mode of “professional”, a resolution of 300 dpi and a color of 24 bit. Image/picture editing software (product name “Adobe Photoshop (trademark)”, manufactured by Adobe) was used to copy an area of 200 pixels×200 pixels of the captured image, paste the copied area to a new clipboard (200 pixels×200 pixels), and convert the resultant to grayscale. Then, a standard deviation obtained from a histogram was determined, and the uniformity of the image was evaluated based on evaluation criteria described below. A smaller standard deviation means that the uniformity of the solid image is better.
A: The standard deviation was less than 3.0.
B: The standard deviation was 3.0 or more to less than 4.0.
C: The standard deviation was 4.0 or more.

### (Transparency of Non-Recording Portion)

With regard to recorded items using a PET film and a PP film, evaluation of the transparency at the non-recording portion was performed. The non-recording portion (region having only the reaction liquid applied thereto) of the recorded item and the release paper of the film not having been subjected to recording were removed, and were attached to a black paper sheet (product name “FSPG Color B Dark”, manufactured by Daio Paper Corporation) while contact with a measurement portion was prevented. A fluorescent spectrodensitometer (product name “FD-7”, manufactured by Konica Minolta, Inc.) was used to measure a lightness L* in the L*a*b* color system. Then, a difference in lightness L* between a region having only the reaction liquid applied thereto and a film not having been subjected to recording was determined, and the transparency of the non-recording portion was evaluated based on evaluation criteria described below.
AA: The difference in L* was less than 2.0.
A: The difference in L* was 2.0 or more to less than 3.0.
B: The difference in L* was 3.0 or more to less than 4.0.
C: The difference in L* was 4.0 or more.

TABLE 5-1
Evaluation condition

| | | | | | | | | Surface | Surface | | Orientation |
|---|---|---|---|---|---|---|---|---|---|---|---|
| | | | | | | | | temperature | temperature | | of |
| | | | | | | | Ratio of | of recording | of recording | | recording |
| | | | | | | | mixture | medium | medium | | surface |
| | | Reaction | | Recording | Recording | Recording | viscosity | after drying | after cooing | | during |
| | | liquid | Ink | medium | apparatus | condition | (times) | (° C.) | (° C.) | Cooling method | drying |
| Example | 1 | 1 | 1 | 1 | 1 | 1 | 70 | 80 | 35 | Blowing air to | Downward |
| | | | | | | | | | | front and back surfaces | |
| | 2 | 1 | 2 | 1 | 1 | 1 | 70 | 80 | 35 | Blowing air to | Downward |
| | | | | | | | | | | front and back surfaces | |
| | 3 | 1 | 3 | 1 | 1 | 1 | 70 | 80 | 35 | Blowing air to | Downward |
| | | | | | | | | | | front and back surfaces | |
| | 4 | 1 | 4 | 1 | 1 | 1 | 70 | 80 | 35 | Blowing air to | Downward |
| | | | | | | | | | | front and back surfaces | |
| | 5 | 1 | 5 | 1 | 1 | 1 | 70 | 80 | 35 | Blowing air to | Downward |
| | | | | | | | | | | front and back surfaces | |
| | 6 | 1 | 1 | 1 | 1 | 1 | 70 | 70 | 35 | Blowing air to | Downward |
| | | | | | | | | | | front and back surfaces | |
| | 7 | 1 | 1 | 1 | 1 | 1 | 70 | 110 | 35 | Blowing air to | Downward |
| | | | | | | | | | | front and back surfaces | |
| | 8 | 1 | 1 | 1 | 1 | 1 | 70 | 80 | 60 | Blowing air to | Downward |
| | | | | | | | | | | front and back surfaces | |
| | 9 | 1 | 1 | 1 | 2 | 1 | 70 | 80 | 35 | Blowing air to | Downward |
| | | | | | | | | | | front and back surfaces | |
| | 10 | 1 | 1 | 1 | 1 | 1 | 70 | 80 | 35 | Blowing air to | Upward |
| | | | | | | | | | | front and back surfaces | |
| | 11 | 1 | 1 | 1 | 1 | 2 | 70 | 80 | 35 | Blowing air to | Downward |
| | | | | | | | | | | front and back surfaces | |
| | 12 | 1 | 1 | 1 | 1 | 3 | 70 | 80 | 35 | Blowing air to | Downward |
| | | | | | | | | | | front and back surfaces | |
| | 13 | 1 | 1 | 1 | 1 | 4 | 70 | 80 | 35 | Blowing air to | Downward |
| | | | | | | | | | | front and back surfaces | |
| | 14 | 1 | 1 | 1 | 1 | 1 | 70 | 80 | 35 | Cooling roll | Downward |
| | 15 | 1 | 1 | 1 | 1 | 1 | 70 | 80 | 20 | Blowing air to | Downward |
| | | | | | | | | | | front and back surfaces | |
| | 16 | 1 | 1 | 1 | 1 | 1 | 70 | 85 | 40 | Blowing air to | Downward |
| | | | | | | | | | | front and back surfaces | |
| | 17 | 1 | 1 | 1 | 1 | 1 | 70 | 80 | 50 | Blowing air to | Downward |
| | | | | | | | | | | front and back surfaces | |
| | 18 | 1 | 1 | 1 | 1 | 1 | 70 | 70 | 50 | Blowing air to | Downward |
| | | | | | | | | | | front and back surfaces | |
| | 19 | 1 | 1 | 1 | 3 | 1 | 70 | 80 | 35 | Blowing air to | Downward |
| | | | | | | | | | | front and back surfaces | |
| | 20 | 1 | 1 | 1 | 4 | 1 | 70 | 80 | 35 | Blowing air to | Downward |
| | | | | | | | | | | front and back surfaces | |

TABLE 5-2
Evaluation condition

| | | | | | | | | Surface | Surface | | Orientation |
|---|---|---|---|---|---|---|---|---|---|---|---|
| | | | | | | | | temperature | temperature | | of |
| | | | | | | | Ratio of | of recording | of recording | | recording |
| | | | | | | | mixture | medium | medium | | surface |
| | | Reaction | | Recording | Recording | Recording | viscosity | after drying | after cooing | | during |
| | | liquid | Ink | medium | apparatus | condition | (times) | (° C.) | (° C.) | Cooling method | drying |
| Example | 21 | 1 | 1 | 1 | 5 | 1 | 70 | 80 | 35 | Blowing air to | Downward |
| | | | | | | | | | | front and back surfaces | |
| | 22 | 1 | 1 | 1 | 6 | 1 | 70 | 80 | 35 | Blowing air to | Downward |
| | | | | | | | | | | front and back surfaces | |
| | 23 | 1 | 1 | 1 | 7 | 1 | 70 | 80 | 35 | Blowing air to | Downward |
| | | | | | | | | | | front and back surfaces | |
| | 24 | 1 | 1 | 1 | 8 | 1 | 70 | 80 | 35 | Blowing air to | Downward |
| | | | | | | | | | | front and back surfaces | |
| | 25 | 1 | 1 | 1 | 9 | 1 | 70 | 80 | 35 | Blowing air to | Downward |
| | | | | | | | | | | front and back surfaces | |
| | 26 | 1 | 1 | 1 | 10 | 1 | 70 | 80 | 35 | Blowing air to | Downward |
| | | | | | | | | | | front and back surfaces | |
| | 27 | 1 | 1 | 1 | 11 | 1 | 70 | 80 | 35 | Blowing air to | Downward |
| | | | | | | | | | | front and back surfaces | |
| | 28 | 1 | 1 | 1 | 12 | 1 | 70 | 80 | 35 | Blowing air to | Downward |
| | | | | | | | | | | front and back surfaces | |
| | 29 | 1 | 1 | 1 | 13 | 1 | 70 | 80 | 35 | Blowing air to | Downward |
| | | | | | | | | | | front and back surfaces | |
| | 30 | 1 | 1 | 1 | 14 | 1 | 70 | 80 | 35 | Blowing air to | Downward |
| | | | | | | | | | | front and back surfaces | |
| | 31 | 1 | 1 | 1 | 15 | 1 | 70 | 80 | 35 | Blowing air to | Downward |
| | | | | | | | | | | front and back surfaces | |
| | 32 | 2 | 1 | 1 | 1 | 1 | 70 | 80 | 35 | Blowing air to | Downward |
| | | | | | | | | | | front and back surfaces | |
| | 33 | 3 | 1 | 1 | 1 | 1 | 70 | 80 | 35 | Blowing air to | Downward |
| | | | | | | | | | | front and back surfaces | |
| | 34 | 4 | 1 | 1 | 1 | 1 | 70 | 80 | 35 | Blowing air to | Downward |
| | | | | | | | | | | front and back surfaces | |
| | 35 | 5 | 1 | 1 | 1 | 1 | 70 | 80 | 35 | Blowing air to | Downward |
| | | | | | | | | | | front and back surfaces | |
| | 36 | 6 | 1 | 1 | 1 | 1 | 70 | 80 | 35 | Blowing air to | Downward |
| | | | | | | | | | | front and back surfaces | |
| | 37 | 7 | 1 | 1 | 1 | 1 | 70 | 80 | 35 | Blowing air to | Downward |
| | | | | | | | | | | front and back surfaces | |
| | 38 | 8 | 1 | 1 | 1 | 1 | 70 | 80 | 35 | Blowing air to | Downward |
| | | | | | | | | | | front and back surfaces | |
| | 39 | 9 | 1 | 1 | 1 | 1 | 70 | 80 | 35 | Blowing air to | Downward |
| | | | | | | | | | | front and back surfaces | |
| | 40 | 10 | 1 | 1 | 1 | 1 | 70 | 80 | 35 | Blowing air to | Downward |
| | | | | | | | | | | front and back surfaces | |

TABLE 5-3
Evaluation condition

| | | | | | | | | Surface | Surface | | Orientation |
|---|---|---|---|---|---|---|---|---|---|---|---|
| | | | | | | | | temperature | temperature | | of |
| | | | | | | | Ratio of | of recording | of recording | | recording |
| | | | | | | | mixture | medium | medium | | surface |
| | | Reaction | | Recording | Recording | Recording | viscosity | after drying | after cooing | | during |
| | | liquid | Ink | medium | apparatus | condition | (times) | (° C.) | (° C.) | Cooling method | drying |
| Example | 41 | 11 | 1 | 1 | 1 | 1 | 70 | 80 | 35 | Blowing air to | Downward |
| | | | | | | | | | | front and back surfaces | |
| | 42 | 12 | 1 | 1 | 1 | 1 | 70 | 80 | 35 | Blowing air to | Downward |
| | | | | | | | | | | front and back surfaces | |
| | 43 | 13 | 1 | 1 | 1 | 1 | 70 | 80 | 35 | Blowing air to | Downward |
| | | | | | | | | | | front and back surfaces | |
| | 44 | 14 | 1 | 1 | 1 | 1 | 70 | 80 | 35 | Blowing air to | Downward |
| | | | | | | | | | | front and back surfaces | |
| | 45 | 15 | 1 | 1 | 1 | 1 | 70 | 80 | 35 | Blowing air to | Downward |
| | | | | | | | | | | front and back surfaces | |
| | 46 | 16 | 1 | 1 | 1 | 1 | 70 | 80 | 35 | Blowing air to | Downward |
| | | | | | | | | | | front and back surfaces | |
| | 47 | 17 | 1 | 1 | 1 | 1 | 70 | 80 | 35 | Blowing air to | Downward |
| | | | | | | | | | | front and back surfaces | |
| | 48 | 18 | 1 | 1 | 1 | 1 | 70 | 80 | 35 | Blowing air to | Downward |
| | | | | | | | | | | front and back surfaces | |
| | 49 | 19 | 1 | 1 | 1 | 1 | 70 | 80 | 35 | Blowing air to | Downward |
| | | | | | | | | | | front and back surfaces | |
| | 50 | 20 | 1 | 1 | 1 | 1 | 70 | 80 | 35 | Blowing air to | Downward |
| | | | | | | | | | | front and back surfaces | |
| | 51 | 1 | 6 | 1 | 1 | 1 | 70 | 80 | 35 | Blowing air to | Downward |
| | | | | | | | | | | front and back surfaces | |
| | 52 | 1 | 7 | 1 | 1 | 1 | 70 | 80 | 35 | Blowing air to | Downward |
| | | | | | | | | | | front and back surfaces | |
| | 53 | 1 | 8 | 1 | 1 | 1 | 70 | 80 | 35 | Blowing air to | Downward |
| | | | | | | | | | | front and back surfaces | |
| | 54 | 1 | 9 | 1 | 1 | 1 | 70 | 80 | 35 | Blowing air to | Downward |
| | | | | | | | | | | front and back surfaces | |
| | 55 | 1 | 10 | 1 | 1 | 1 | 70 | 80 | 35 | Blowing air to | Downward |
| | | | | | | | | | | front and back surfaces | |
| | 56 | 1 | 11 | 1 | 1 | 1 | 70 | 80 | 35 | Blowing air to | Downward |
| | | | | | | | | | | front and back surfaces | |
| | 57 | 1 | 12 | 1 | 1 | 1 | 70 | 80 | 35 | Blowing air to | Downward |
| | | | | | | | | | | front and back surfaces | |
| | 58 | 1 | 1 | 1 | 1 | 5 | 8 | 80 | 35 | Blowing air to | Downward |
| | | | | | | | | | | front and back surfaces | |
| | 59 | 1 | 1 | 1 | 1 | 6 | 10 | 80 | 35 | Blowing air to | Downward |
| | | | | | | | | | | front and back surfaces | |
| | 60 | 1 | 1 | 1 | 1 | 7 | 100 | 80 | 35 | Blowing air to | Downward |
| | | | | | | | | | | front and back surfaces | |

TABLE 5-4
Evaluation condition

| | | | | | | | | Surface | Surface | | Orientation |
|---|---|---|---|---|---|---|---|---|---|---|---|
| | | | | | | | | temperature | temperature | | of |
| | | | | | | | Ratio of | of recording | of recording | | recording |
| | | | | | | | mixture | medium | medium | | surface |
| | | Reaction | | Recording | Recording | Recording | viscosity | after drying | after cooing | | during |
| | | liquid | Ink | medium | apparatus | condition | (times) | (° C.) | (° C.) | Cooling method | drying |
| Example | 61 | 1 | 1 | 1 | 1 | 8 | >110 | 80 | 35 | Blowing air to | Downward |
| | | | | | | | | | | front and back surfaces | |
| | 62 | 21 | 13 | 1 | 1 | 1 | 70 | 80 | 35 | Blowing air to | Downward |
| | | | | | | | | | | front and back surfaces | |
| | 63 | 22 | 14 | 1 | 1 | 1 | 70 | 80 | 35 | Blowing air to | Downward |
| | | | | | | | | | | front and back surfaces | |
| | 64 | 1 | 1 | 2 | 1 | 1 | 70 | 80 | 35 | Blowing air to | Downward |
| | | | | | | | | | | front and back surfaces | |
| | 65 | 1 | 1 | 3 | 1 | 1 | 70 | 80 | 35 | Blowing air to | Downward |
| | | | | | | | | | | front and back surfaces | |
| | 66 | 1 | 1 | 4 | 1 | 1 | 70 | 80 | 35 | Blowing air to | Downward |
| | | | | | | | | | | front and back surfaces | |
| | 67 | 1 | 1 | 5 | 1 | 1 | 70 | 80 | 35 | Blowing air to | Downward |
| | | | | | | | | | | front and back surfaces | |
| | 68 | 1 | 1 | 1 | 1 | 9 | 70 | 80 | 35 | Blowing air to | Downward |
| | | | | | | | | | | front and back surfaces | |
| | 69 | 1 | 1 | 1 | 1 | 10 | 70 | 80 | 35 | Blowing air to | Downward |
| | | | | | | | | | | front and back surfaces | |
| | 70 | 1 | 1 | 1 | 1 | 11 | 70 | 80 | 35 | Blowing air to | Downward |
| | | | | | | | | | | front and back surfaces | |
| | 71 | 1 | 1 | 1 | 1 | 12 | 70 | 80 | 35 | Blowing air to | Downward |
| | | | | | | | | | | front and back surfaces | |
| | 72 | 23 | 15 | 3 | 16 | 13 | 8 | 80 | 50 | Cooling roll | Upward |

TABLE 5-5
Evaluation condition

| | | | | | | | | Surface | Surface | | Orientation |
|---|---|---|---|---|---|---|---|---|---|---|---|
| | | | | | | | | temperature | temperature | | of |
| | | | | | | | Ratio of | of recording | of recording | | recording |
| | | | | | | | mixture | medium | medium | | surface |
| | | Reaction | | Recording | Recording | Recording | viscosity | after drying | after cooing | | during |
| | | liquid | Ink | medium | apparatus | condition | (times) | (° C.) | (° C.) | Cooling method | drying |
| Comparative | 1 | — | 1 | 1 | 1 | 1 | 70 | 80 | 25 | Blowing air to | Downward |
| Example | | | | | | | | | | front and back surfaces | |
| | 2 | 1 | 1 | 1 | 1 | 1 | 70 | 25 | 25 | None | None |
| | 3 | 1 | 1 | 1 | 1 | 1 | 70 | 50 | 25 | Blowing air to | Downward |
| | | | | | | | | | | front and back surfaces | |
| | 4 | 1 | 1 | 1 | 1 | 1 | 70 | 80 | 70 | None | Downward |
| | 5 | 1 | 2 | 1 | 1 | 1 | 70 | 80 | 70 | None | Downward |
| | 6 | 1 | 3 | 1 | 1 | 1 | 70 | 80 | 70 | None | Downward |
| | 7 | 1 | 4 | 1 | 1 | 1 | 70 | 80 | 70 | None | Downward |
| | 8 | 1 | 5 | 1 | 1 | 1 | 70 | 80 | 70 | None | Downward |
| | 9 | 2 | 1 | 1 | 1 | 1 | 70 | 80 | 70 | None | Downward |
| | 10 | 7 | 1 | 1 | 1 | 1 | 70 | 80 | 70 | None | Downward |
| | 11 | 8 | 1 | 1 | 1 | 1 | 70 | 80 | 70 | None | Downward |
| | 12 | 1 | 1 | 1 | 1 | 1 | 70 | 80 | 35 (>5 | Radiational cooling | Downward |
| | | | | | | | | | seconds) | | |
| Reference | 1 | 1 | 1 | 6 | 17 | 1 | 70 | 80 | 35 | Blowing air to | Upward |
| example | | | | | | | | | | front and back surfaces | |
| | 2 | 1 | 1 | 1 | 18 | 1 | 70 | 80 | 35 | Blowing air to | Upward |
| | | | | | | | | | | front and back surfaces | |

TABLE 6-1
Evaluation result

| | | | | Warpage | | Transparency |
|---|---|---|---|---|---|---|
| | | | Scratch | of | | of Non- |
| | | Blocking | caused by | recording | Unifor- | recording |
| | | resistance | tightening | medium | mity | Portion |
| Exam- | 1 | AA | AA | A | A | AA |
| ple | 2 | AA | AA | A | A | AA |
| | 3 | AA | AA | A | A | AA |
| | 4 | AA | AA | A | A | AA |
| | 5 | AA | AA | A | A | AA |
| | 6 | AA | AA | A | A | AA |
| | 7 | AA | AA | A | A | AA |
| | 8 | AA | B | A | A | AA |
| | 9 | B | AA | A | A | AA |
| | 10 | AA | A | A | A | AA |
| | 11 | A | AA | A | A | AA |
| | 12 | AA | AA | A | A | AA |
| | 13 | AA | AA | A | A | AA |
| | 14 | AA | AA | B | A | AA |
| | 15 | AA | AA | A | A | AA |
| | 16 | AA | AA | A | A | AA |
| | 17 | AA | A | A | A | AA |
| | 18 | AA | A | A | A | AA |
| | 19 | A | AA | A | A | AA |
| | 20 | B | AA | A | A | AA |
| | 21 | A | AA | A | A | AA |
| | 22 | A | AA | A | A | AA |
| | 23 | AA | AA | A | A | AA |
| | 24 | AA | AA | A | A | AA |
| | 25 | AA | AA | A | A | AA |
| | 26 | AA | AA | A | A | AA |
| | 27 | A | AA | A | A | AA |
| | 28 | A | AA | A | A | AA |
| | 29 | A | AA | A | A | AA |
| | 30 | AA | AA | A | A | AA |

TABLE 6-2
Evaluation result

| | | | | Warpage | | Transparency |
|---|---|---|---|---|---|---|
| | | | Scratch | of | | of Non- |
| | | Blocking | caused by | recording | Unifor- | recording |
| | | resistance | tightening | medium | mity | Portion |
| Exam- | 31 | AA | AA | A | A | AA |
| ple | 32 | AA | AA | A | B | AA |
| | 33 | AA | A | A | A | AA |
| | 34 | AA | A | A | A | AA |
| | 35 | A | B | A | A | AA |
| | 36 | A | B | A | A | AA |
| | 37 | B | B | A | A | B |
| | 38 | B | AA | A | A | B |
| | 39 | AA | AA | A | A | AA |
| | 40 | AA | AA | A | A | AA |
| | 41 | AA | A | A | A | A |
| | 42 | AA | AA | A | A | AA |
| | 43 | AA | AA | A | A | A |
| | 44 | AA | AA | A | A | A |
| | 45 | A | AA | A | A | B |
| | 46 | A | AA | A | A | B |
| | 47 | AA | AA | A | A | A |
| | 48 | AA | AA | A | A | B |
| | 49 | AA | AA | A | A | B |
| | 50 | A | AA | A | A | B |
| | 51 | B | A | A | A | AA |
| | 52 | B | B | A | A | AA |
| | 53 | A | A | A | A | AA |
| | 54 | A | AA | A | A | AA |
| | 55 | AA | AA | A | A | AA |
| | 56 | AA | A | A | A | AA |
| | 57 | AA | AA | A | A | AA |
| | 58 | AA | AA | A | B | AA |
| | 59 | AA | AA | A | A | AA |
| | 60 | AA | AA | A | A | AA |

TABLE 6-3
Evaluation result

| | | | | Warpage | | Transparency |
|---|---|---|---|---|---|---|
| | | | Scratch | of | | of |
| | | Blocking | caused by | recording | | Non-recording |
| | | resistance | tightening | medium | Uniformity | Portion |
| Example | 61 | A | AA | A | A | AA |
| | 62 | AA | AA | A | A | AA |
| | 63 | A | AA | A | A | AA |
| | 64 | AA | A | B | A | — |
| | 65 | AA | A | B | A | — |
| | 66 | AA | AA | A | A | — |
| | 67 | AA | AA | A | A | — |
| | 68 | AA | AA | A | B | AA |
| | 69 | AA | AA | A | A | AA |
| | 70 | AA | AA | A | A | AA |
| | 71 | A | AA | A | A | AA |
| | 72 | B | B | B | B | B |
| Comparative | 1 | AA | AA | A | C | AA |
| Example | 2 | C | A | A | A | C |
| | 3 | C | AA | A | A | C |
| | 4 | A | C | C | A | AA |
| | 5 | A | C | C | A | AA |
| | 6 | A | C | C | A | AA |
| | 7 | A | C | C | A | AA |
| | 8 | A | C | C | A | AA |
| | 9 | A | C | C | A | AA |
| | 10 | C | C | C | B | B |
| | 11 | A | C | C | A | B |
| | 12 | AA | AA | C | A | AA |
| Reference | 1 | B | AA | C | A | AA |
| example | 2 | A | AA | A | A | AA |

According to the present invention, there can be provided the ink jet recording method capable of recording a high-quality image that is less liable to cause blocking and generate a scratch caused by tightening and that is reduced in unevenness and warpage even when a recording medium having been subjected to image recording is wound up into a roll. In addition, according to the present invention, the ink jet recording apparatus to be used in the ink jet recording method can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-188259, filed Nov. 25, 2022, Japanese Patent Application No. 2022-188251, filed Nov. 25, 2022, and Japanese Patent Application No. 2023-196036, filed Nov. 17, 2023, which are hereby incorporated by reference herein in their entirety.

What is claimed is:

1. An ink jet recording method of recording an image on a roll of recording medium with use of an aqueous ink and an aqueous reaction liquid comprising a reactant that reacts with the aqueous ink, the ink jet recording method comprising:
a reaction liquid applying step of applying the aqueous reaction liquid to the recording medium;
an ink applying step of applying the aqueous ink to the recording medium so that a region to which the aqueous ink is applied and a region to which the reaction liquid is applied are at least partially overlap on the recording medium;
a drying step of drying the aqueous ink by applying hot air such that a surface temperature of the recording medium is increased to 70° C. or more;
a cooling step of decreasing the surface temperature of the recording medium given at a time point of 5 seconds after an end of the drying step by 20° C. or more; and
a wind-up step of winding up the cooled recording medium into a roll.

2. The ink jet recording method according to claim 1, wherein the drying step comprises applying hot air to a front surface of the recording medium under a state in which the front surface of the recording medium faces downward.

3. The ink jet recording method according to claim 1, wherein the cooling step comprises blowing air to a front surface and a back surface of the recording medium to decrease the surface temperature of the recording medium.

4. The ink jet recording method according to claim 1, wherein the wind-up step comprises winding up the recording medium with a recording face of the recording medium being located on an outer side.

5. The ink jet recording method according to claim 1, further comprising a bending step of bending the recording medium between (i) each of the reaction liquid applying step and the ink applying step and (ii) the drying step.

6. The ink jet recording method according to claim 5, wherein the bending step comprises bending the recording medium with a recording face of the recording medium facing outward.

7. The ink jet recording method according to claim 5, wherein the bending step comprises bending the recording medium at a bending angle of 80° or more.

8. The ink jet recording method according to claim 5, wherein the bending step comprises bending the recording medium with a bending radius of 20 cm or less.

9. The ink jet recording method according to claim 1, further comprising, after the drying step, a fixing step of fixing an image by applying pressure to a recording face of the recording medium.

10. The ink jet recording method according to claim 9, wherein the fixing step comprises applying a pressure of 30 Pa or more to the recording face of the recording medium.

11. The ink jet recording method according to claim 1, wherein the aqueous reaction liquid comprises a polyvalent metal salt having a water solubility at 20° C. of 8% by mass or more to 30% by mass or less.

12. The ink jet recording method according to claim 11, wherein a content (% by mass) of the polyvalent metal salt in the aqueous reaction liquid is 10.0% by mass or less based on a total mass of the aqueous reaction liquid.

13. The ink jet recording method according to claim 11, wherein the polyvalent metal salt is magnesium sulfate.

14. The ink jet recording method according to claim 1, wherein the aqueous reaction liquid comprises a water-soluble organic solvent having a boiling point of 250° C. or less.

15. The ink jet recording method according to claim 14, wherein a moisture absorption rate of the water-soluble organic solvent is 60% or less.

16. The ink jet recording method according to claim 1, wherein the aqueous ink comprises a water-soluble organic solvent having a boiling point of 250° C. or less.

17. The ink jet recording method according to claim 1, wherein a ratio of a viscosity (mPa·s) of a mixed liquid obtained by mixing 1.00 part by mass of the aqueous ink and 0.08 part by mass or more to 0.40 part by mass or less of the aqueous reaction liquid at 25° C. with respect to a viscosity (mPa·s) of the aqueous ink at 25° C. is 10 times or more to 100 times or less.

18. The ink jet recording method according to claim 1, wherein a surface tension of the aqueous ink and a surface tension of the aqueous reaction liquid are each 39 mN/m or less.

19. The ink jet recording method according to claim 1, wherein the recording medium is one of a film or a sheet made of at least one kind of material selected from the group consisting of: polyethylene; polypropylene; nylon; polyethylene terephthalate; polyvinyl chloride; and a metal.

20. An ink jet recording apparatus to be used in an ink jet recording method comprising recording an image on a roll of recording medium with use of an aqueous ink and an aqueous reaction liquid comprising a reactant that reacts with the aqueous ink, the ink jet recording apparatus comprising:
a reaction liquid application unit configured to apply the aqueous reaction liquid to the recording medium;
an ink application unit configured to apply the aqueous ink to the recording medium so that a region to which the aqueous ink is applied and a region to which the reaction liquid is applied are at least partially overlap on the recording medium;
a drying unit configured to dry the aqueous ink by applying hot air such that a surface temperature of the recording medium is increased to 70° C. or more;
a cooling unit configured to decrease the surface temperature of the recording medium given at a time point of 5 seconds after an end of the drying by 20° C. or more; and
a wind-up unit configured to wind up the cooled recording medium into a roll.
